(19) United States
(12) Patent Application Publication
(10) Pub. No.: US 2025/0056626 A1
(43) Pub. Date: Feb. 13, 2025

(54) METHOD AND APPARATUS FOR FALLBACK ACTION OF SMALL DATA TRANSMISSION IN A WIRELESS COMMUNICATION SYSTEM

(71) Applicant: ASUSTek Computer Inc., Taipei City (TW)

(72) Inventors: Yi-Hsuan Huang, Taipei City (TW); Meng-Hui Ou, Taipei City (TW)

(21) Appl. No.: 18/933,134

(22) Filed: Oct. 31, 2024

Related U.S. Application Data
(62) Division of application No. 17/167,670, filed on Feb. 4, 2021.
(60) Provisional application No. 62/976,017, filed on Feb. 13, 2020.

(51) Int. Cl. H04W 74/0833; H04W 76/10

(52) U.S. Cl. CPC H04W 74/0833; H04W 76/10

(57) ABSTRACT

A method and device are disclosed from the perspective of a User Equipment (UE). In one embodiment, the method includes the UE initiating a 2-step Random Access (RA) procedure including Uplink (UL) data in RRC_INACTIVE state. The method further includes the UE switching from the 2-step RA procedure to a 4-step RA procedure not including the UL data in response to a condition.

### CROSS-REFERENCE TO RELATED APPLICATIONS

The present Application claims priority to and is a divisional of U.S. application Ser. No. 17/167,670, filed on Feb. 4, 2021, entitled “METHOD AND APPARATUS FOR FALLBACK ACTION OF SMALL DATA TRANSMISSION IN A WIRELESS COMMUNICATION SYSTEM”, the entire disclosure of which is incorporated herein in its entirety by reference. U.S. application Ser. No. 17/167,670 claims the benefit of U.S. Provisional Patent Application Ser. No. 62/976,017 filed on Feb. 13, 2020, the entire disclosure of which is incorporated herein in their entirety by reference.

### FIELD

This disclosure generally relates to wireless communication networks, and more particularly, to a method and apparatus for fallback action of small data transmission in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

A method and device are disclosed from the perspective of a User Equipment (UE). In one embodiment, the method includes the UE initiating a 2-step Random Access (RA) procedure including the Uplink (UL) data in RRC_INACTIVE state. The method further includes the UE switching from the 2-step RA procedure to a 4-step RA procedure not including UL data in response to a condition.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of Table 5.1.4-1 of 3GPP TS 36.321 V15.8.0.

FIG. 6 is a flow chart of a 2-step random access procedure with small data according with one exemplary embodiment.

FIG. 7 is a flow chart of a 4-step random access procedure with small data according with one exemplary embodiment.

FIG. 8 is a flow chart according to one exemplary embodiment.

FIG. 9 is a flow chart according to one exemplary embodiment.

FIG. 10 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio), or some other modulation techniques.

In particular, the exemplary wireless communication systems devices described below may be designed to support one or more standards such as the standard offered by a consortium named “3rd Generation Partnership Project” referred to herein as 3GPP, including: TS 38.321 V15.8.0, “NR, Medium Access Control (MAC) protocol specification”; R2-1914798, “Running MAC CR for 2-step RACH”, ZTE Corporation, Sanechips; R2-1915889, “Stage-2 running CR for 2-step RACH”, Nokia, Nokia Shanghai Bell; 3GPP TS 38.331 V15.8.0, “NR, Radio Resource Control (RRC) protocol specification”; TS 36.300 V15.8.0, “E-UTRA and E-UTRAN; Overall description; Stage 2”; TS 36.321 V15.8.0, “E-UTRA; Medium Access Control (MAC) protocol specification”; TS 36.331 V15.8.0, “E-UTRA, Radio Resource Control (RRC) protocol specification”; RP-193252, “Work Item on NR small data transmissions in INACTIVE state”, ZTE Corporation; and RP-193238, “New SID on support of reduced capability NR devices”, Ericsson. The standards and documents listed above are hereby expressly incorporated by reference in their entirety.

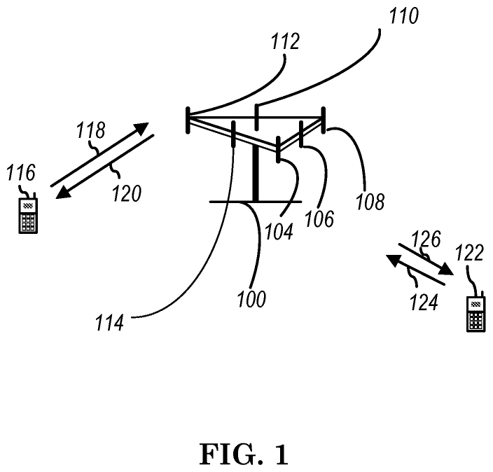

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), a network node, a network, or some other terminology. An access terminal (AT) may also be called user equipment (UE), a wireless communication device, terminal, access terminal or some other terminology.

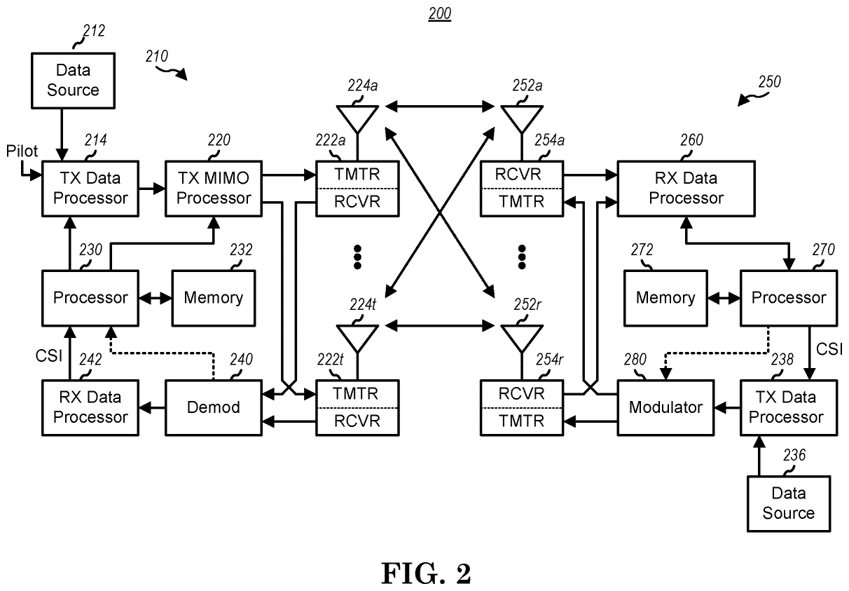

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides NT modulation symbol streams to Nr transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. Nr modulated signals from transmitters 222a through 222t are then transmitted from NT antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide NT “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

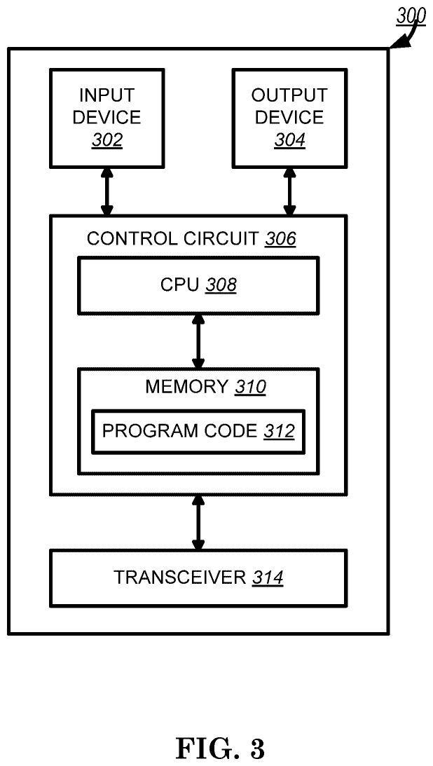

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

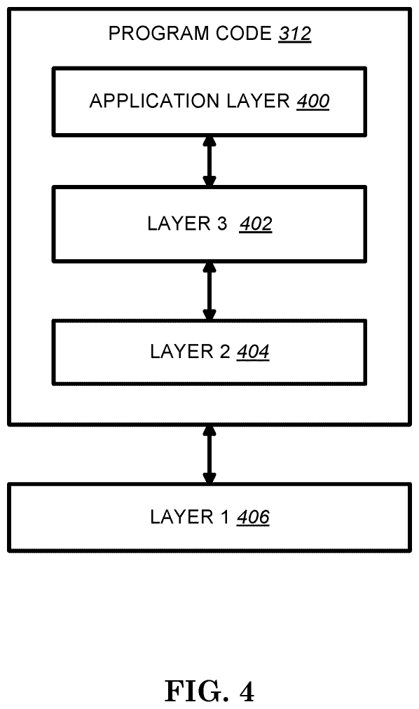

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

In NR, the RA procedure is specified in 3GPP TS 38.321 with the running CR R2-1914798 as follows:

### 5.1 Random Access Procedure

### 5.1.1 Random Access Procedure Initialization

The Random Access procedure described in this clause is initiated by a PDCCH order, by the MAC entity itself, or by RRC for the events in accordance with TS 38.300 [2]. There is only one Random Access procedure ongoing at any point in time in a MAC entity. The Random Access procedure on an SCell shall only be initiated by a PDCCH order with ra-PreambleIndex different from 0b000000.
NOTE 1: If a new Random Access procedure is triggered while another is already ongoing in the MAC entity, it is up to UE implementation whether to continue with the ongoing procedure or start with the new procedure (e.g. for SI request).
   RRC configures the following parameters for the Random Access procedure:
Editor's Note: The RRC parameters for 2-step random access will be added here (RAN1 input needed for power control related parameters etc). The names of the IEs listed below are also FFS and can be revisited later.
   prach-ConfigurationIndex: the available set of PRACH occasions for the transmission of the Random Access Preamble;
   preambleReceivedTargetPower: initial Random Access Preamble power;
   rsrp-ThresholdSSB: an RSRP threshold for the selection of the SSB. If the Random Access procedure is initiated for beam failure recovery, rsrp-ThresholdSSB used for the selection of the SSB within candidateBeamRSList refers to rsrp-ThresholdSSB in BeamFailureRecoveryConfig IE;
   rsrp-ThresholdCSI-RS: an RSRP threshold for the selection of CSI-RS. If the Random Access procedure is initiated for beam failure recovery, rsrp-ThresholdCSI-RS is equal to rsrp-ThresholdSSB in BeamFailureRecoveryConfig IE;
   rsrp-ThresholdSSB-SUL: an RSRP threshold for the selection between the NUL carrier and the SUL carrier;
   rsrp-ThresholdSSB-2stepCBRA: an RSRP threshold for selection of 2-step random access candidateBeamRSList: a list of reference signals (CSI-RS and/or SSB) identifying the candidate beams for recovery and the associated Random Access parameters;
   recoverySearchSpaceld: the search space identity for monitoring the response of the beam failure recovery request;
   powerRampingStep: the power-ramping factor;
   powerRampingStepHighPriority: the power-ramping factor in case of prioritized Random Access procedure;
   scalingFactorBI: a scaling factor for prioritized Random Access procedure;
   ra-PreambleIndex: Random Access Preamble;
   ra-ssb-OccasionMaskIndex: defines PRACH occasion(s) associated with an SSB in which the MAC entity may transmit a Random Access Preamble (see clause 7.4);
   ra-OccasionList: defines PRACH occasion(s) associated with a CSI-RS in which the MAC entity may transmit a Random Access Preamble;
   ra-PreambleStartIndex: the starting index of Random Access Preamble(s) for on-demand SI request;
   preamble TransMax: the maximum number of Random Access Preamble transmission;
   ssb-perRACH-OccasionAndCB-PreamblesPerSSB: defines the number of SSBs mapped to each PRACH occasion and the number of contention-based Random Access Preambles mapped to each SSB;
   if groupBconfigured is configured, then Random Access Preambles group B is configured.
      Amongst the contention-based Random Access Preambles associated with an SSB (as defined in TS 38.213 [6]), the first numberOfRA-PreamblesGroupA Random Access Preambles belong to Random Access Preambles group A. The remaining Random Access Preambles associated with the SSB belong to Random Access Preambles group B (if configured).
NOTE 2: If Random Access Preambles group B is supported by the cell Random Access Preambles group B is included for each SSB.
   if Random Access Preambles group B is configured:
      ra-Msg3SizeGroupA: the threshold to determine the groups of Random Access Preambles;
      msg3-DeltaPreamble: Δ_{PREAMBLE_Msg3} in TS 38.213 [6];
      messagePowerOffsetGroupB: the power offset for preamble selection;
      numberOfRA-PreamblesGroupA: defines the number of Random Access Preambles in Random Access Preamble group A for each SSB.
Editor's Note: the configuration of group B preambles for 2-step RACH etc need to be added above.
   the set of Random Access Preambles and/or PRACH occasions for SI request, if any;
   the set of Random Access Preambles and/or PRACH occasions for beam failure recovery request, if any;
   the set of Random Access Preambles and/or PRACH occasions for reconfiguration with sync, if any;
   ra-ResponseWindow: the time window to monitor RA response(s) (SpCell only);
   ra-ContentionResolutionTimer: the Contention Resolution Timer (SpCell only).
      In addition, the following information for related Serving Cell is assumed to be available for UEs:
if Random Access Preambles group B is configured:
   if the Serving Cell for the Random Access procedure is configured with supplementary uplink as specified in TS 38.331 [5], and SUL carrier is selected for performing Random Access Procedure:
      P_{CMAX,f,c} of the SUL carrier as specified in TS 38.101-1 [14], TS 38.101-2 [15], and TS 38.101-3 [16].
   else:
      P_{CMAX,f,c} of the NUL carrier as specified in TS 38.101-1 [14], TS 38.101-2 [15], and TS 38.101-3 [16].
         The following UE variables are used for the Random Access procedure:
Editor's Note: The variables for 2-step random access to be added here
   PREAMBLE_INDEX;
   PREAMBLE_TRANSMISSION_COUNTER;
   PREAMBLE_POWER_RAMPING_COUNTER;
   PREAMBLE_POWER_RAMPING_STEP;
   PREAMBLE_RECEIVED_TARGET_POWER;
   PREAMBLE_BACKOFF;
   PCMAX;
   SCALING_FACTOR_BI;
   TEMPORARY_C-RNTI.
   RA_TYPE.
      When the Random Access procedure is initiated on a Serving Cell, the MAC entity shall:
1>flush the Msg3 buffer;
1>flush the MSGA buffer;
1>set the PREAMBLE_TRANSMISSION_COUNTER to 1;
1>set the PREAMBLE_POWER_RAMPING_COUNTER to 1;
1>set the PREAMBLE_BACKOFF to 0 ms;
1>if the carrier to use for the Random Access procedure is explicitly signalled:
   2>select the signalled carrier for performing Random Access procedure;
   2>set the PCMAX to P_{CMAX,f,c} of the signalled carrier.
1>else if the carrier to use for the Random Access procedure is not explicitly signalled; and
1>if the Serving Cell for the Random Access procedure is configured with supplementary uplink as specified in TS 38.331 [5]; and
1>if the RSRP of the downlink pathloss reference is less than rsrp-ThresholdSSB-SUL:
   2>select the SUL carrier for performing Random Access procedure;
   2>set the PCMAX to P_{CMAX,f,c} of the SUL carrier.
1>else:
   2>select the NUL carrier for performing Random Access procedure;
   2>set the PCMAX to PCMAX, f,c of the NUL carrier.
1>perform the BWP operation as specified in clause 5.15;
Editor's Note: It is FFS how to select the RA_TYPE if 4-step CFRA is configured (either for BFR or for HO). The logic below to select the RA_TYPE needs to be updated (and can also be simplified) after the agreements about the 4-step CFRA for BFR/HO.
1>if random access procedure is initiated by PDCCH order and if the ra-PreambleIndex explicitly provided by PDCCH is not 0b000000; or
1>if the Random Access procedure was initiated for SI request (as specified in TS 38.331 [5]) and the Random Access Resources for SI request have been explicitly provided by RRC:
   2>set the RA_TYPE to 4-stepRA;
1>else if the rsrp-ThresholdSSB-2stepCBRA is configured and the RSRP of the downlink pathloss reference is above the configured rsrp-ThresholdSSB-2stepCBRA; or
1>if the BWP selected for random access procedure is only configured with 2-step random access resources (i.e. no 4-step RACH resources configured):
   2>set the RA_TYPE to 2-stepRA;
1>else:
   2>set the RA_TYPE to 4-stepRA;
1>if RA_TYPE is set to 2-stepRA:
   2>set PREAMBLE_POWER_RAMPING_STEP to powerRampingStep;
   2>set SCALING_FACTOR_BI to 1;
   2>if the Random Access procedure was initiated for beam failure recovery (as specified in clause 5.17); and
   2>if beamFailureRecoveryConfig is configured for the active UL BWP of the selected carrier:
      3>if powerRampingStepHighPriority is configured in the beamFailureRecoveryConfig:
         4>set PREAMBLE_POWER_RAMPING_STEP to the powerRampingStepHighPriority.
      3>if scalingFactorBI is configured in the beamFailureRecoveryConfig:
         4>set SCALING_FACTOR_BI to the scalingFactorBI.
2>else if the Random Access procedure was initiated for handover; and
   2>if rach-ConfigDedicated is configured for the selected carrier:
      3>if powerRampingStepHighPriority is configured in the rach-ConfigDedicated:
         4>set PREAMBLE_POWER_RAMPING_STEP to the powerRampingStepHighPriority.
      3>if scalingFactorBI is configured in the rach-ConfigDedicated:
         4>set SCALING_FACTOR_BI to the scalingFactorBI.
Editor's Note: The above configuration names are FFS. It is also FFS whether these variables are common between 2-step and 4-step RACH. We need to update the variable names and the parameter names depending on the final decision on whether the configuration parameters are common to 2-step and 4-step RACH or not (to be updated based on the RRC parameter email discussion for example).
   2>perform the random access resource selection procedure for 2-step random access (see clause 5.1.2a).
1>else: (i.e. RA_TYPE is set to 4-stepRA)
   2>set PREAMBLE_POWER_RAMPING_STEP to powerRampingStep;
   2>set SCALING_FACTOR_BI to 1;
   2>if the Random Access procedure was initiated for beam failure recovery (as specified in clause 5.17); and
   2>if beamFailureRecoveryConfig is configured for the active UL BWP of the selected carrier:
      3>start the beamFailureRecoveryTimer, if configured;
      3>apply the parameters powerRampingStep, preambleReceivedTargetPower, and preambleTransMax configured in the beamFailureRecoveryConfig;
      3>if powerRampingStepHighPriority is configured in the beamFailureRecoveryConfig:
         4>set PREAMBLE_POWER_RAMPING_STEP to the powerRampingStepHighPriority.
      3>if scalingFactorBI is configured in the beamFailureRecoveryConfig:
         4>set SCALING_FACTOR_BI to the scalingFactorBI.
   2>else if the Random Access procedure was initiated for handover; and
   2>if rach-ConfigDedicated is configured for the selected carrier:
      3>if powerRampingStepHighPriority is configured in the rach-ConfigDedicated:
         4>set PREAMBLE_POWER_RAMPING_STEP to the powerRampingStepHighPriority.
      3>if scalingFactorBI is configured in the rach-ConfigDedicated:
         4>set SCALING_FACTOR_BI to the scalingFactorBI.
   2>perform the Random Access Resource selection procedure (see clause 5.1.2).

### 5.1.2 Random Access Resource Selection

The MAC entity shall:

1>if the Random Access procedure was initiated for beam failure recovery (as specified in clause 5.17); and
1>if the beamFailureRecoveryTimer (in clause 5.17) is either running or not configured; and
1>if the contention-free Random Access Resources for beam failure recovery request associated with any of the SSBs and/or CSI-RSs have been explicitly provided by RRC; and
1>if at least one of the SSBs with SS-RSRP above rsrp-ThresholdSSB amongst the SSBs in candidateBeamRSList or the CSI-RSs with CSI-RSRP above rsrp-ThresholdCSI-RS amongst the CSI-RSs in candidateBeamRSList is available:
   2>select an SSB with SS-RSRP above rsrp-ThresholdSSB amongst the SSBs in candidateBeamRSList or a CSI-RS with CSI-RSRP above rsrp-ThresholdCSI-RS amongst the CSI-RSs in candidateBeamRSList;
   2>if CSI-RS is selected, and there is no ra-PreambleIndex associated with the selected CSI-RS:
      3>set the PREAMBLE_INDEX to a ra-PreambleIndex corresponding to the SSB in candidateBeamRSList which is quasi-colocated with the selected CSI-RS as specified in TS 38.214 [7].
   2>else:
      3>set the PREAMBLE_INDEX to a ra-PreambleIndex corresponding to the selected SSB or CSI-RS from the set of Random Access Preambles for beam failure recovery request.
1>else if the ra-PreambleIndex has been explicitly provided by PDCCH; and
1>if the ra-PreambleIndex is not 0b000000:
   2>set the PREAMBLE_INDEX to the signalled ra-PreambleIndex;
   2>select the SSB signalled by PDCCH.
1>else if the contention-free Random Access Resources associated with SSBs have been explicitly provided in rach-ConfigDedicated and at least one SSB with SS-RSRP above rsrp-ThresholdSSB amongst the associated SSBs is available:
   2>select an SSB with SS-RSRP above rsrp-ThresholdSSB amongst the associated SSBs;
   2>set the PREAMBLE_INDEX to a ra-PreambleIndex corresponding to the selected SSB.
1>else if the contention-free Random Access Resources associated with CSI-RSs have been explicitly provided in rach-ConfigDedicated and at least one CSI-RS with CSI-RSRP above rsrp-ThresholdCSI-RS amongst the associated CSI-RSs is available:
   2>select a CSI-RS with CSI-RSRP above rsrp-ThresholdCSI-RS amongst the associated CSI-RSS;
   2>set the PREAMBLE_INDEX to a ra-PreambleIndex corresponding to the selected CSI-RS.
1>else if the Random Access procedure was initiated for SI request (as specified in TS 38.331 [5]); and
1>if the Random Access Resources for SI request have been explicitly provided by RRC:
   2>if at least one of the SSBs with SS-RSRP above rsrp-ThresholdSSB is available:
      3>select an SSB with SS-RSRP above rsrp-ThresholdSSB.
   2>else:
      3>select any SSB.
   2>select a Random Access Preamble corresponding to the selected SSB, from the Random Access Preamble(s) determined according to ra-PreambleStartIndex as specified in TS 38.331 [5];
   2>set the PREAMBLE_INDEX to selected Random Access Preamble.
1>else (i.e. for the contention-based Random Access preamble selection):
   2>if at least one of the SSBs with SS-RSRP above rsrp-ThresholdSSB is available:
      3>select an SSB with SS-RSRP above rsrp-ThresholdSSB.
   2>else:
      3>select any SSB.
   2>if Msg3 buffer is not empty:
      3>if Random Access Preambles group B is configured:
         4>if the potential Msg3 size (UL data available for transmission plus MAC header and, where required, MAC CEs) is greater than ra-Msg3SizeGroupA and the pathloss is less than PCMAX (of the Serving Cell performing the Random Access Procedure)-preambleReceivedTargetPower-msg3-DeltaPreamble-messagePowerOffsetGroupB; or
         4>if the Random Access procedure was initiated for the CCCH logical channel and the CCCH SDU size plus MAC subheader is greater than ra-Msg3SizeGroupA:
         5>select the Random Access Preambles group B.
         4>else:
         5>select the Random Access Preambles group A.
      3>else:
         4>select the Random Access Preambles group A.
   2>else (i.e. Msg3 is being retransmitted):
      3>select the same group of Random Access Preambles as was used for the Random Access Preamble transmission attempt corresponding to the first transmission of Msg3.
   2>select a Random Access Preamble randomly with equal probability from the Random Access Preambles associated with the selected SSB and the selected Random Access Preambles group.
   2>set the PREAMBLE_INDEX to the selected Random Access Preamble.
1>if the Random Access procedure was initiated for SI request (as specified in TS 38.331 [5]); and
1>if ra-AssociationPeriodIndex and si-RequestPeriod are configured:
   2>determine the next available PRACH occasion from the PRACH occasions corresponding to the selected SSB in the association period given by ra-AssociationPeriodIndex in the si-RequestPeriod permitted by the restrictions given by the ra-ssb-OccasionMaskIndex if configured (the MAC entity shall select a PRACH occasion randomly with equal probability amongst the consecutive PRACH occasions according to clause 8.1 of TS 38.213 [6] corresponding to the selected SSB).
1>else if an SSB is selected above:
   2>determine the next available PRACH occasion from the PRACH occasions corresponding to the selected SSB permitted by the restrictions given by the ra-ssb-OccasionMaskIndex if configured or indicated by PDCCH (the MAC entity shall select a PRACH occasion randomly with equal probability amongst the consecutive PRACH occasions according to clause 8.1 of TS 38.213 [6], corresponding to the selected SSB; the MAC entity may take into account the possible occurrence of measurement gaps when determining the next available PRACH occasion corresponding to the selected SSB).
1>else if a CSI-RS is selected above:
   2>if there is no contention-free Random Access Resource associated with the selected CSI-RS:
      3>determine the next available PRACH occasion from the PRACH occasions, permitted by the restrictions given by the ra-ssb-OccasionMaskIndex if configured, corresponding to the SSB in candidateBeamRSList which is quasi-colocated with the selected CSI-RS as specified in TS 38.214 [7] (the MAC entity shall select a PRACH occasion randomly with equal probability amongst the consecutive PRACH occasions according to clause 8.1 of TS 38.213 [6], corresponding to the SSB which is quasi-colocated with the selected CSI-RS; the MAC entity may take into account the possible occurrence of measurement gaps when determining the next available PRACH occasion corresponding to the SSB which is quasi-colocated with the selected CSI-RS).
   2>else:
      3>determine the next available PRACH occasion from the PRACH occasions in ra-OccasionList corresponding to the selected CSI-RS (the MAC entity shall select a PRACH occasion randomly with equal probability amongst the PRACH occasions occurring simultaneously but on different subcarriers, corresponding to the selected CSI-RS; the MAC entity may take into account the possible occurrence of measurement gaps when determining the next available PRACH occasion corresponding to the selected CSI-RS).
1>perform the Random Access Preamble transmission procedure (see clause 5.1.3).
NOTE: When the UE determines if there is an SSB with SS-RSRP above rsrp-ThresholdSSB or a CSI-RS with CSI-RSRP above rsrp-ThresholdCSI-RS, the UE uses the latest unfiltered L1-RSRP measurement.

### 5.1.2a Random Access Resource Selection for 2-Step Random Access

The MAC entity shall:
1>if at least one of the SSBs with SS-RSRP above rsrp-ThresholdSSB is available:
   2>select an SSB with SS-RSRP above rsrp-ThresholdSSB.
1>else:
   2>select any SSB.
1>if MSGA has not yet been transmitted:
   2>if Random Access Preambles group B for 2-step RA is configured:
      3>if the potential MSGA payload size (UL data available for transmission plus MAC header and, where required, MAC CEs) is greater than [ra-MsgASizeGroupA] and the pathloss is less than PCMAX (of the Serving Cell performing the Random Access Procedure)−[preambleReceivedTargetPower]−[msgA-DeltaPreamble]−[messagePowerOffsetGroupB]; or
      3>if the Random Access procedure was initiated for the CCCH logical channel and the CCCH SDU size plus MAC subheader is greater than [ra-MsgASizeGroupA]:
         4>select the Random Access Preambles group B.
      3>else:
         4>select the Random Access Preambles group A.
   2>else:
      3>select the Random Access Preambles group A.
1>else (i.e. MSGA is being retransmitted):
   2>select the same group of Random Access Preambles as was used for the Random Access Preamble transmission attempt corresponding to the first transmission of MSGA.
Editor's Note: The variable names above and whether these are same or different to corresponding variables in 4-step RACH is FFS.
1>select a Random Access Preamble randomly with equal probability from the 2-step Random Access Preambles associated with the selected SSB and the selected Random Access Preambles group;
1>set the PREAMBLE_INDEX to the selected Random Access Preamble;
1>determine the next available PRACH occasion from the PRACH occasions corresponding to the selected SSB (the MAC entity shall select a PRACH occasion randomly with equal probability among the consecutive PRACH occasions allocated for 2-step random access according to subclause 8.1 of TS 38.213 [6], corresponding to the selected SSB; the MAC entity may take into account the possible occurrence of measurement gaps when determining the next available PRACH occasion corresponding to the selected SSB);
1>determine the UL grant and the associated HARQ information for the PUSCH resource of MSGA associated with the selected preamble and PRACH occasion according to subclause x of TS 38.213 [6];
1>deliver the UL grant and the associated HARQ information to the HARQ entity;
Editor's Note: The aspects related to the selection of PUSCH resource and payload size of MSGA are FFS (pending RAN1 input). The above sentence can be changed based on further discussion in RAN2 and RAN1 hence.
1>perform the MSGA transmission procedure (see subclause 5.1.3a).
NOTE: To determine if there is an SSB with SS-RSRP above rsrp-ThresholdSSB, the UE uses the latest unfiltered L1-RSRP measurement.

### 5.1.3 Random Access Preamble Transmission

The MAC entity shall, for each Random Access Preamble:
1>if PREAMBLE_TRANSMISSION_COUNTER is greater than one; and
1>if the notification of suspending power ramping counter has not been received from lower layers; and
1>if SSB or CSI-RS selected is not changed from the selection in the last Random Access Preamble transmission:
   2>increment PREAMBLE_POWER_RAMPING_COUNTER by 1.
1>select the value of DELTA_PREAMBLE according to clause 7.3;
1>set PREAMBLE_RECEIVED_TARGET_POWER to preambleReceivedTargetPower+DELTA_PREAMBLE+ (PREAMBLE_POWER_RAMPING_COUNTER−1)×PREAMBLE_POWER_RAMPING_STEP;
1>except for contention-free Random Access Preamble for beam failure recovery request, compute the RA-RNTI associated with the PRACH occasion in which the Random Access Preamble is transmitted;
1>instruct the physical layer to transmit the Random Access Preamble using the selected PRACH occasion, corresponding RA-RNTI (if available), PREAMBLE_INDEX and PREAMBLE_RECEIVED_TARGET_POWER.
   The RA-RNTI associated with the PRACH occasion in which the Random Access Preamble is transmitted, is computed as:

$$RA - RNTI = 1 + s\_id + 14 \times t\_id + 14 \times 80 \times f\_id + 14 \times 80 \times 8 \times ul\_carrier \_id$$

where s_id is the index of the first OFDM symbol of the PRACH occasion (0≤s_id<14), t_id is the index of the first slot of the PRACH occasion in a system frame (0 $ t_id<80), where the subcarrier spacing to determine t_id is based on the value of u specified in clause 5.3.2 in TS 38.211 [8], f_id is the index of the PRACH occasion in the frequency domain (0≤f_id<8), and ul_carrier_id is the UL carrier used for Random Access Preamble transmission (0 for NUL carrier, and 1 for SUL carrier).

### 5.1.3a MSGA Transmission

Editor's Note: The handling of the counters in this section are FFS for now. The description below is for information and will be updated based on the input from RAN1 on how to handle the power ramping counters. Also, the calculation of RA-RNTI will also be updated based on further agreements (both in RAN1 and RAN2 on whether to use a new RNTI etc), so, this is also for information only
   The MAC entity shall, for each MSGA:
1>if PREAMBLE_TRANSMISSION_COUNTER is greater than one; and
1>if the notification of suspending power ramping counter has not been received from lower layers; and
1>if SSB selected is not changed from the selection in the last Random Access Preamble transmission:
   2>increment PREAMBLE_POWER_RAMPING_COUNTER by 1.
1>select the value of DELTA_PREAMBLE according to subclause 7.3;
1>set PREAMBLE_RECEIVED_TARGET_POWER to preambleReceivedTargetPower+DELTA_PREAMBLE+ (PREAMBLE_POWER_RAMPING_COUNTER−1)×PREAMBLE_POWER_RAMPING_STEP;
1>if this is the first MSGA transmission within this Random Access procedure:
   2>if the transmission is not being made for the CCCH logical channel:
      3>indicate to the Multiplexing and assembly entity to include a C-RNTI MAC CE in the subsequent uplink transmission.
   2>obtain the MAC PDU to transmit from the Multiplexing and assembly entity and store it in the MSGA buffer.
1>compute the MSGB-RNTI associated with the PRACH occasion in which the Random Access Preamble is transmitted;
1>instruct the physical layer to transmit the MSGA using the selected PRACH occasion and the associated PUSCH resource, using the corresponding RA-RNTI, MSGB-RNTI, PREAMBLE_INDEX, PREAMBLE_RECEIVED_TARGET_POWER.
NOTE: The MSGA transmission includes the transmission of the PRACH Preamble as well as the contents of the MSGA buffer in the PUSCH resource corresponding to the selected PRACH occasion and PREAMBLE_INDEX (see TS 38.213 [6])
   The MSGB-RNTI associated with the PRACH occasion in which the Random Access Preamble is transmitted, is computed as:

### FFS

### Editor's Note: MSGB-RNTI Format and Details are FFS

### 5.1.4 Random Access Response Reception

Once the Random Access Preamble is transmitted and regardless of the possible occurrence of a measurement gap, the MAC entity shall:
1>if the contention-free Random Access Preamble for beam failure recovery request was transmitted by the MAC entity:
   2>start the ra-ResponseWindow configured in BeamFailureRecoveryConfig at the first PDCCH occasion as specified in TS 38.213 [6] from the end of the Random Access Preamble transmission;
   2>monitor for a PDCCH transmission on the search space indicated by recoverySearchSpaceld of the SpCell identified by the C-RNTI while ra-ResponseWindow is running.
1>else:
   2>start the ra-Response Window configured in RACH-ConfigCommon at the first PDCCH occasion as specified in TS 38.213 [6] from the end of the Random Access Preamble transmission;
   2>monitor the PDCCH of the SpCell for Random Access Response(s) identified by the RA-RNTI while the ra-ResponseWindow is running.
1>if notification of a reception of a PDCCH transmission on the search space indicated by recoverySearchSpaceld is received from lower layers on the Serving Cell where the preamble was transmitted; and
1>if PDCCH transmission is addressed to the C-RNTI; and
1>if the contention-free Random Access Preamble for beam failure recovery request was transmitted by the MAC entity:
   2>consider the Random Access procedure successfully completed.
1>else if a downlink assignment has been received on the PDCCH for the RA-RNTI and the received TB is successfully decoded:
   2>if the Random Access Response contains a MAC subPDU with Backoff Indicator:
      3>set the PREAMBLE_BACKOFF to value of the BI field of the MAC subPDU using Table 7.2-1, multiplied with SCALING_FACTOR_BI.
   2>else:
      3>set the PREAMBLE_BACKOFF to 0 ms.
   2>if the Random Access Response contains a MAC subPDU with Random Access Preamble identifier corresponding to the transmitted PREAMBLE_INDEX (see clause 5.1.3):
      3>consider this Random Access Response reception successful.
   2>if the Random Access Response reception is considered successful:
      3>if the Random Access Response includes a MAC subPDU with RAPID only:
         4>consider this Random Access procedure successfully completed;
         4>indicate the reception of an acknowledgement for SI request to upper layers.
      3>else:
         4>apply the following actions for the Serving Cell where the Random Access Preamble was transmitted:
         5>process the received Timing Advance Command (see clause 5.2);
         5>indicate the preambleReceivedTargetPower and the amount of power ramping applied to the latest Random Access Preamble transmission to lower layers (i.e. (PREAMBLE_POWER_RAMPING_COUNTER−1)×PREAMBLE_POWER_RAMPING_STEP);
         5>if the Serving Cell for the Random Access procedure is SRS-only SCell:
         6>ignore the received UL grant.
         5>else:
         6>process the received UL grant value and indicate it to the lower layers.
         4>if the Random Access Preamble was not selected by the MAC entity among the contention-based Random Access Preamble(s):
         5>consider the Random Access procedure successfully completed.
         4>else:
         5>set the TEMPORARY_C-RNTI to the value received in the Random Access Response;
         5>if this is the first successfully received Random Access Response within this Random Access procedure:
         6>if the transmission is not being made for the CCCH logical channel:
         7>indicate to the Multiplexing and assembly entity to include a C-RNTI MAC CE in the subsequent uplink transmission.
         6>obtain the MAC PDU to transmit from the Multiplexing and assembly entity and store it in the Msg3 buffer.
NOTE: If within a Random Access procedure, an uplink grant provided in the Random Access Response for the same group of contention-based Random Access Preambles has a different size than the first uplink grant allocated during that Random Access procedure, the UE behavior is not defined.
1>if ra-ResponseWindow configured in BeamFailureRecoveryConfig expires and if a PDCCH transmission on the search space indicated by recoverySearchSpaceld addressed to the C-RNTI has not been received on the Serving Cell where the preamble was transmitted; or
1>if ra-Response Window configured in RACH-ConfigCommon expires, and if the Random Access Response containing Random Access Preamble identifiers that matches the transmitted PREAMBLE_INDEX has not been received:
   2>consider the Random Access Response reception not successful;
   2>increment PREAMBLE_TRANSMISSION_COUNTER by 1;
   2>if PREAMBLE_TRANSMISSION_COUNTER=preamble TransMax+1:
      3>if the Random Access Preamble is transmitted on the SpCell:
         4>indicate a Random Access problem to upper layers;
         4>if this Random Access procedure was triggered for SI request:
         5>consider the Random Access procedure unsuccessfully completed.
      3>else if the Random Access Preamble is transmitted on a SCell:
         4>consider the Random Access procedure unsuccessfully completed.
   2>if the Random Access procedure is not completed:
      3>select a random backoff time according to a uniform distribution between 0 and the PREAMBLE_BACKOFF;
      3>if the criteria (as defined in clause 5.1.2) to select contention-free Random Access Resources is met during the backoff time:
         4>perform the Random Access Resource selection procedure (see clause 5.1.2);
      3>else:
         4>perform the Random Access Resource selection procedure (see clause 5.1.2) after the backoff time.
            The MAC entity may stop ra-Response Window (and hence monitoring for Random Access Response(s)) after successful reception of a Random Access Response containing Random Access Preamble identifiers that matches the transmitted PREAMBLE_INDEX.
            HARQ operation is not applicable to the Random Access Response reception.

### 5.1.4a MSGB Reception and Contention Resolution for 2-Step Random Access

Editor's Note: the handling of counters and other RAN1 related parameters for power control can be updated after further information from RAN1. The names of the variables is also FFS and can be changed later.
   Once the MSGA is transmitted, regardless of the possible occurrence of a measurement gap, the MAC entity shall:
1>start the msgB-ResponseWindow at the first PDCCH occasion from the end of the MSGA transmission as specified in TS 38.213 [6];
1>monitor the PDCCH of the SpCell for a random access response identified by MSGB-RNTI while the msgB-ResponseWindow is running;
1>if C-RNTI MAC CE was included in the MSGA:
   2>monitor the PDCCH of the SpCell for random access response identified by the C-RNTI while the msgB-ResponseWindow is running;
1>if notification of a reception of a PDCCH transmission of the SpCell is received from lower layers:
   2>if the C-RNTI MAC CE was included in MSGA:
      3>if the Random Access procedure was initiated for beam failure recovery (as specified in clause 5.17) and the PDCCH transmission is addressed to the C-RNTI:
         4>consider this Random Access Response reception successful;
         4>consider this Random Access procedure successfully completed.
Editor's Note: The above text for BFR needs endorsement by RAN2. We did not agree any new conditions for BFR. However, considering that the intention is to not have a separate search space for BFR response reception, it seems companies are okay to leave the handling of any false positives to network implementation. Thus, the above text basically implements the minimum needed per the Rel-15 BFR procedure.
   3>else if the timeAlignmentTimer associated with the PTAG is running:
      4>if the PDCCH transmission is addressed to the C-RNTI and contains a UL grant for a new transmission:
         5>consider this Random Access Response reception successful;
         5>consider this Random Access procedure successfully completed.
   3>else:
      4>if a downlink assignment has been received on the PDCCH for the C-RNTI and the received TB is successfully decoded:
         5>if the MAC PDU contains the Absolute Timing Advance Command MAC CE:
         6>consider this Random Access Response reception successful;
         6>consider this Random Access procedure successfully completed.
2>if a downlink assignment has been received on the PDCCH for the MSGB-RNTI and the received TB is successfully decoded:
   3>if the MSGB contains a MAC subPDU with Backoff Indicator:
      4>set the PREAMBLE_BACKOFF to value of the BI field of the MAC subPDU using Table 7.2-1.
   3>else:
      4>set the PREAMBLE_BACKOFF to 0 ms.
   3>if the MSGB contains a fallbackRAR MAC subPDU; and
   3>if the Random Access Preamble identifier in the MAC subPDU matches the transmitted PREAMBLE_INDEX (see subclause 5.1.3a):
      4>consider this Random Access Response reception successful;
      4>apply the following actions for the SpCell:
         5>process the received Timing Advance Command (see clause 5.2);
         5>set the TEMPORARY_C-RNTI to the value received in the fallbackRAR;
         5>indicate the preambleReceivedTargetPower and the amount of power ramping applied to the latest Random Access Preamble transmission to lower layers (i.e. (PREAMBLE_POWER_RAMPING_COUNTER−1)×PREAMBLE_POWER_RAMPING_STEP);
Editor's Note: It is FFS whether the MAC should provide the above power control related parameters to physical layer per above
   5>if the Msg3 buffer is empty:
      6>obtain the MAC PDU to transmit from the MSGA buffer and store it in the Msg3 buffer;
   5>process the received UL grant value and indicate it to the lower layers and proceed with Msg3 transmission;
NOTE: If within a 2-step random access procedure, an uplink grant provided in the fallback RAR has a different size than the MSGA payload, the UE behavior is not defined.
   3>else if the MSGB contains a successRAR MAC subPDU; and
   3>if the CCCH SDU was included in the MSGA and the UE Contention Resolution Identity in the MAC subPDU matches the CCCH SDU:
      4>if this Random Access procedure was initiated for SI request:
         5>indicate the reception of an acknowledgement for SI request to upper layers.
      4>else:
         5>set the C-RNTI to the value received in the successRAR;
         5>apply the following actions for the SpCell:
         6>process the received Timing Advance Command (see subclause 5.2);
         6>indicate the preambleReceivedTargetPower and the amount of power ramping applied to the latest Random Access Preamble transmission to lower layers (i.e. (PREAMBLE_POWER_RAMPING_COUNTER−1)×PREAMBLE_POWER_RAMPING_STEP);
Editor's Note: It is FFS whether the MAC should provide the above power control related parameters to physical layer per above
   4>consider this Random Access Response reception successful;
   4>consider this Random Access procedure successfully completed;
   4>finish the disassembly and demultiplexing of the MAC PDU.
1>if msgB-Response Window expires, and the Random Access Response Reception has not been considered as successful based on descriptions above:
   2>increment PREAMBLE_TRANSMISSION_COUNTER by 1;
   2>if PREAMBLE_TRANSMISSION_COUNTER=preamble TransMax+1:
      3>indicate a Random Access problem to upper layers;
      3>if this Random Access procedure was triggered for SI request:
         4>consider this Random Access procedure unsuccessfully completed.
   2>if the Random Access procedure is not completed:
      3>select a random backoff time according to a uniform distribution between 0 and the PREAMBLE_BACKOFF;
      3>if msgATransMax is configured, and PREAMBLE_TRANSMISSION_COUNTER=msgATransMax+1:
         4>set the RA_TYPE to 4-stepRA;
         4>if the Msg3 buffer is empty:
         5>obtain the MAC PDU to transmit from the MSGA buffer and store it in the Msg3 buffer;
         4>flush HARQ buffer used for the transmission of MAC PDU in the MSGA buffer.
         4>perform the Random Access Resource selection procedure as specified in subclause 5.1.2.
      3>else:
         4>perform the Random Access Resource selection procedure for 2-step random access (see subclause 5.1.2a) after the backoff time.
            The MAC Entity May Stop msgB-Response Window Once the Random Access Response Reception is Considered as Successful
Editor's Note: Feedback for successful reception of MSGB is FFS pending RAN1 input

### 5.1.5 Contention Resolution

Once Msg3 is transmitted, the MAC entity shall:
1>start the ra-ContentionResolutionTimer and restart the ra-ContentionResolutionTimer at each HARQ retransmission in the first symbol after the end of the Msg3 transmission;
1>monitor the PDCCH while the ra-ContentionResolutionTimer is running regardless of the possible occurrence of a measurement gap;
1>if notification of a reception of a PDCCH transmission of the SpCell is received from lower layers:
   2>if the C-RNTI MAC CE was included in Msg3:
      3>if the Random Access procedure was initiated for beam failure recovery (as specified in clause 5.17) and the PDCCH transmission is addressed to the C-RNTI; or
      3>if the Random Access procedure was initiated by a PDCCH order and the PDCCH transmission is addressed to the C-RNTI; or
      3>if the Random Access procedure was initiated by the MAC sublayer itself or by the RRC sublayer and the PDCCH transmission is addressed to the C-RNTI and contains a UL grant for a new transmission:
         4>consider this Contention Resolution successful;
         4>stop ra-ContentionResolutionTimer;
         4>discard the TEMPORARY_C-RNTI;
         4>consider this Random Access procedure successfully completed.
   2>else if the CCCH SDU was included in Msg3 and the PDCCH transmission is addressed to its TEMPORARY_C-RNTI:
      3>if the MAC PDU is successfully decoded:
         4>stop ra-ContentionResolutionTimer;
         4>if the MAC PDU contains a UE Contention Resolution Identity MAC CE; and
         4>if the UE Contention Resolution Identity in the MAC CE matches the CCCH SDU transmitted in Msg3:
         5>consider this Contention Resolution successful and finish the disassembly and demultiplexing of the MAC PDU;
         5>if this Random Access procedure was initiated for SI request:
         6>indicate the reception of an acknowledgement for SI request to upper layers.
         5>else:
         6>set the C-RNTI to the value of the TEMPORARY_C-RNTI;
         5>discard the TEMPORARY_C-RNTI;
         5>consider this Random Access procedure successfully completed.
         4>else:
         5>discard the TEMPORARY_C-RNTI;
         5>consider this Contention Resolution not successful and discard the successfully decoded MAC PDU.
1>if ra-ContentionResolutionTimer expires:
   2>discard the TEMPORARY_C-RNTI;
   2>consider the Contention Resolution not successful.
1>if the Contention Resolution is considered not successful:
   2>flush the HARQ buffer used for transmission of the MAC PDU in the Msg3 buffer;
   2>increment PREAMBLE_TRANSMISSION_COUNTER by 1;
   2>if PREAMBLE_TRANSMISSION_COUNTER=preamble TransMax+1:
Editor's Note: The above condition applies for both 4-step RACH and the fallback case of 2-step RACH. This needs to be checked after final decision on handling of counters.
   3>indicate a Random Access problem to upper layers.
   3>if this Random Access procedure was triggered for SI request:
      4>consider the Random Access procedure unsuccessfully completed.
   2>if the Random Access procedure is not completed:
      3>select a random backoff time according to a uniform distribution between 0 and the PREAMBLE_BACKOFF;
      3>if the criteria (as defined in clause 5.1.2) to select contention-free Random Access Resources is met during the backoff time:
         4>perform the Random Access Resource selection procedure (see clause 5.1.2);
      3>else if the RA_TYPE is set to 2-stepRA:
         4>if msgATransMax is configured and PREAMBLE_TRANSMISSION_COUNTER=msgATransMax+1:
         5>set the RA_TYPE to 4-stepRA;
         5>flush HARQ buffer used for the transmission of MAC PDU in the MSGA buffer.
         5>perform the Random Access Resource selection as specified in subclause 5.1.2.
         4>else:
         5>perform the Random Access Resource selection for 2-step random access procedure (see clause 5.1.2a) after the backoff time.
      3>else:
         4>perform the Random Access Resource selection as specified in subclause 5.1.2 after the backoff time.

In LTE, the Random Access (RA) procedure with early data transmission (EDT) in RRC_IDLE state is specified in 3GPP TS 36.321 as follows:

### 5.1.4 Random Access Response Reception

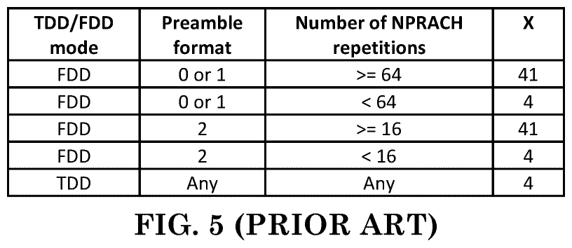

Once the Random Access Preamble is transmitted and regardless of the possible occurrence of a measurement gap or a Sidelink Discovery Gap for Transmission or a Sidelink Discovery Gap for Reception, and regardless of the prioritization of V2X sidelink communication described in clause 5.14.1.2.2, the MAC entity shall monitor the PDCCH of the SpCell for Random Access Response(s) identified by the RA-RNTI defined below, in the RA Response window which starts at the subframe that contains the end of the preamble transmission, as specified in TS 36.211 [7], plus three subframes and has length ra-ResponseWindowSize. If the UE is a BLUE or a UE in enhanced coverage, RA Response window starts at the subframe that contains the end of the last preamble repetition plus three subframes and has length ra-ResponseWindowSize for the corresponding enhanced coverage level. If the UE is an NB-IoT UE, RA Response window starts at the subframe that contains the end of the last preamble repetition plus X subframes and has length ra-ResponseWindowSize for the corresponding enhanced coverage level, where value X is determined from Table 5.1.4-1 based on the used preamble format and the number of NPRACH repetitions.
[Table 5.1.4-1 of 3GPP TS 36.321 V15.8.0, entitled “Subframes between preamble transmission and RA Response Window in NB-IoT”, is reproduced as FIG. 5]
   The RA-RNTI associated with the PRACH in which the Random Access Preamble is transmitted, is computed as:

$$RA - RNTI = 1 + t\_id + 10 * f\_id$$

where t_id is the index of the first subframe of the specified PRACH (0≤t_id<10), and f_id is the index of the specified PRACH within that subframe, in ascending order of frequency domain (0≤ f_id<6) except for NB-IoT UEs, BL UEs or UEs in enhanced coverage. If the PRACH resource is on a TDD carrier, the f_id is set to fRA, where fRA is defined in clause 5.7.1 of TS 36.211 [7].
For BL UEs and UEs in enhanced coverage, RA-RNTI associated with the PRACH in which the Random Access Preamble is transmitted, is computed as:

$$RA - RNTI = 1 + t\_id + 10 * f\_id + 60 * ( SFN\_id mod ( W max / 10 ) )$$

where t_id is the index of the first subframe of the specified PRACH (0s t_id<10), f_id is the index of the specified PRACH within that subframe, in ascending order of frequency domain (0≤ f_id<6), SFN_id is the index of the first radio frame of the specified PRACH, and Wmax is 400, maximum possible RAR window size in subframes for BL UEs or UEs in enhanced coverage. If the PRACH resource is on a TDD carrier, the f_id is set to fra, where fra is defined in clause 5.7.1 of TS 36.211 [7].
For NB-IoT UEs, the RA-RNTI associated with the PRACH in which the Random Access Preamble is transmitted, is computed as:

$$RA - RNTI = 1 + floor ( SFN\_id / 4 ) + 256 * carrier\_id$$

where SFN_id is the index of the first radio frame of the specified PRACH and carrier_id is the index of the UL carrier associated with the specified PRACH. The carrier_id of the anchor carrier is 0.
For NB-IoT UEs operating in TDD mode, the RA-RNTI associated with the PRACH in which the Random Access Preamble is transmitted, is computed as:

$$RA - RNTI = 1 + floor ( SFN\_id / 4 ) + 256 * ( H - SFN mod 2 )$$

where SFN_id is the index of the first radio frame of the specified PRACH and H-SFN is the index of the first hyper frame of the specified PRACH. The PDCCH transmission and the PRACH resource are on the same carrier.
The MAC entity may stop monitoring for Random Access Response(s) after successful reception of a Random Access Response containing Random Access Preamble identifiers that matches the transmitted Random Access Preamble.
If a downlink assignment for this TTI has been received on the PDCCH for the RA-RNTI and the received TB is successfully decoded, the MAC entity shall regardless of the possible occurrence of a measurement gap or a Sidelink Discovery Gap for Transmission or a Sidelink Discovery Gap for Reception, and regardless of the prioritization of V2X sidelink communication described in clause 5.14.1.2.2:
   if the Random Access Response contains a Backoff Indicator subheader:
      set the backoff parameter value as indicated by the BI field of the Backoff Indicator subheader and Table 7.2-1, except for NB-IoT where the value from Table 7.2-2 is used.
   else, set the backoff parameter value to 0 ms.
   if the Random Access Response contains a Random Access Preamble identifier corresponding to the transmitted Random Access Preamble (see clause 5.1.3), the MAC entity shall:
      consider this Random Access Response reception successful and apply the following actions for the serving cell where the Random Access Preamble was transmitted:
   process the received Timing Advance Command (see clause 5.2);
   indicate the preambleInitialReceivedTargetPower and the amount of power ramping applied to the latest preamble transmission to lower layers (i.e., (PREAMBLE_TRANSMISSION_COUNTER−1)*powerRampingStep);
   if the SCell is configured with ul-Configuration-r14, ignore the received UL grant otherwise process the received UL grant value and indicate it to the lower layers;
   if, except for NB-IoT, ra-PreambleIndex was explicitly signalled and it was not 000000 (i.e., not selected by MAC):
      consider the Random Access procedure successfully completed.
      else if, the UE is an NB-IoT UE, ra-PreambleIndex was explicitly signalled and it was not 000000 (i.e., not selected by MAC) and ra-CFRA-Config is configured:
      consider the Random Access procedure successfully completed.
      the UL grant provided in the Random Access Response message is valid only for the configured carrier (i.e. UL carrier used prior to this Random Access procedure).
      else:
      if the Random Access Preamble was selected by the MAC entity; or
      if the UE is an NB-IoT UE, the ra-PreambleIndex was explicitly signalled and it was not 000000 and ra-CFRA-Config is not configured:
         set the Temporary C-RNTI to the value received in the Random Access Response message no later than at the time of the first transmission corresponding to the UL grant provided in the Random Access Response message;
         if the Random Access Preamble associated with EDT was transmitted and UL grant provided in the Random Access Response message is not for EDT:
         indicate to upper layers that EDT is cancelled due to UL grant not being for EDT;
         for CP-EDT, flush the Msg3 buffer.
         for UP-EDT, update the MAC PDU in the Msg3 buffer in accordance with the uplink grant received in the Random Access Response.
         if the Random Access Preamble associated with EDT was transmitted, the UL grant was received in a Random Access Response for EDT, and there is a MAC PDU in the Msg3 buffer:
         if the TB size according to edt-SmallTBS-Enabled and as described in clause 8.6.2 and 16.3.3 of TS 36.213 [2] does not match the size of the MAC PDU in the Msg3 buffer:
         the MAC entity shall update the MAC PDU in the Msg3 buffer in accordance with the TB size.
         if this is the first successfully received Random Access Response within this Random Access procedure; or
         if CP-EDT is cancelled due to the UL grant provided in the Random Access Response message not being for EDT:
         if the transmission is not being made for the CCCH logical channel, indicate to the Multiplexing and assembly entity to include a C-RNTI MAC control element in the subsequent uplink transmission;
         obtain the MAC PDU to transmit from the “Multiplexing and assembly” entity and store it in the Msg3 buffer.
NOTE 1: When an uplink transmission is required, e.g., for contention resolution, the eNB should not provide a grant smaller than 56 bits (or 88 bits for NB-IoT) in the Random Access Response.
NOTE 2: If within a Random Access procedure, an uplink grant provided in the Random Access Response for the same group of Random Access Preambles has a different size than the first uplink grant allocated during that Random Access procedure, the UE behavior is not defined except for EDT.
   If no Random Access Response or, for NB-IoT UEs, BL UEs or UEs in enhanced coverage for mode B operation, no PDCCH scheduling Random Access Response is received within the RA Response window, or if none of all received Random Access Responses contains a Random Access Preamble identifier corresponding to the transmitted Random Access Preamble, the Random Access Response reception is considered not successful and the MAC entity shall:
if the notification of power ramping suspension has not been received from lower layers:
   increment PREAMBLE_TRANSMISSION_COUNTER by 1;
if the UE is an NB-IoT UE, a BL UE or a UE in enhanced coverage:
   if PREAMBLE_TRANSMISSION_COUNTER=preamble TransMax-CE+1:
      if the Random Access Preamble is transmitted on the SpCell:
      indicate a Random Access problem to upper layers;
      if NB-IoT:
         consider the Random Access procedure unsuccessfully completed;
else:
   if PREAMBLE_TRANSMISSION_COUNTER=preambleTransMax+1:
      1 if the Random Access Preamble is transmitted on the SpCell:
      indicate a Random Access problem to upper layers;
      if the Random Access Preamble is transmitted on an SCell:
      consider the Random Access procedure unsuccessfully completed.
if in this Random Access procedure, the Random Access Preamble was selected by MAC:
   based on the backoff parameter, select a random backoff time according to a uniform distribution between 0 and the Backoff Parameter Value;
   delay the subsequent Random Access transmission by the backoff time;
else if the SCell where the Random Access Preamble was transmitted is configured with ul-Configuration-r14:
   delay the subsequent Random Access transmission until the Random Access Procedure is initiated by a PDCCH order with the same ra-PreambleIndex and ra-PRACH-MaskIndex;
if the UE is an NB-IoT UE, a BL UE or a UE in enhanced coverage:
   increment PREAMBLE_TRANSMISSION_COUNTER_CE by 1;
   if PREAMBLE_TRANSMISSION_COUNTER_CE=maxNumPreambleAttemptCE for the corresponding enhanced coverage level+1:
      reset PREAMBLE_TRANSMISSION_COUNTER_CE;
      consider to be in the next enhanced coverage level, if it is supported by the Serving Cell and the UE, otherwise stay in the current enhanced coverage level;
      if the UE is an NB-IoT UE:
      if the Random Access Procedure was initiated by a PDCCH order:
         select the PRACH resource in the list of UL carriers providing a PRACH resource for the selected enhanced coverage level for which the carrier index is equal to ((Carrier Indication from the PDCCH order) modulo (Number of PRACH resources in the selected enhanced coverage));
         consider the selected PRACH resource as explicitly signalled;
proceed to the selection of a Random Access Resource (see clause 5.1.2).

The work item of small data transmissions in RRC_INACTIVE state in NR has been approved in RAN plenary #86 meeting. The description of the work item is specified in 3GPP RP-193252 as follows:

### 3 Justification

NR supports RRC_INACTIVE state and UEs with infrequent (periodic and/or non-periodic) data transmission are generally maintained by the network in the RRC_INACTIVE state. Until Rel-16, the RRC_INACTIVE state doesn't support data transmission. Hence, the UE has to resume the connection (i.e. move to RRC_CONNECTED state) for any DL (MT) and UL (MO) data. Connection setup and subsequently release to INACTIVE state happens for each data transmission however small and infrequent the data packets are. This results in unnecessary power consumption and signalling overhead.
Specific examples of small and infrequent data traffic include the following use cases:
Smartphone applications:
   Traffic from Instant Messaging services (whatsapp, QQ, wechat etc)
   Heart-beat/keep-alive traffic from IM/email clients and other apps
   Push notifications from various applications
Non-smartphone applications:
   Traffic from wearables (periodic positioning information etc)
   sensors (Industrial Wireless Sensor Networks transmitting temperature, pressure readings periodically or in an event triggered manner etc)
   smart meters and smart meter networks sending periodic meter readings
      As noted in 3GPP TS 22.891, the NR system shall:
be efficient and flexible for low throughput short data bursts
support efficient signalling mechanisms (e.g. signalling is less than payload)
reduce signalling overhead in general
   Signalling overhead from INACTIVE state UEs for small data packets is a general problem and will become a critical issue with more UEs in NR not only for network performance and efficiency but also for the UE battery performance. In general, any device that has intermittent small data packets in INACTIVE state will benefit from enabling small data transmission in INACTIVE.
   The key enablers for small data transmission in NR, namely the INACTIVE state, 2-step, 4-step RACH and configured grant type-1 have already been specified as part of Rel-15 and Rel-16. So, this work builds on these building blocks to enable small data transmission in INACTIVE state for NR.

### 4 Objective

### 4.1 Objective of SI or Core Part WI or Testing Part WI

This work item enables small data transmission in RRC_INACTIVE state as follows:
For the RRC_INACTIVE state:
   UL small data transmissions for RACH-based schemes (i.e. 2-step and 4-step RACH):
      General procedure to enable UP data transmission for small data packets from INACTIVE state (e.g. using MSGA or MSG3) [RAN2]
      Enable flexible payload sizes larger than the Rel-16 CCCH message size that is possible currently for INACTIVE state for MSGA and MSG3 to support UP data transmission in UL (actual payload size can be up to network configuration) [RAN2]
      Context fetch and data forwarding (with and without anchor relocation) in INACTIVE state for RACH-based solutions [RAN2, RAN3]
   Note 1: The security aspects of the above solutions should be checked with SA3
Transmission of UL data on pre-configured PUSCH resources (i.e. reusing the configured grant type 1)—when TA is valid
   General procedure for small data transmission over configured grant type 1 resources from INACTIVE state [RAN2]
   Configuration of the configured grant type1 resources for small data transmission in UL for INACTIVE state [RAN2]
      No new RRC state should be introduced in this WID. Transmission of small data in UL, subsequent transmission of small data in UL and DL and the state transition decisions should be under network control.
      Focus of the WID should be on licensed carriers and the solutions can be reused for NR-U if applicable.
      Note 2: Any associated specification work in RAN1 that is needed to support the above set of objectives should be initiated by RAN2 via an LS.

A UE transmits data in RRC_CONNECTED state, and could transit to RRC_INACTIVE state to save the power when there is no data transmission. Upon data arrival while the UE is in RRC_INACTIVE state, the UE could resume the Radio Resource Control (RRC) connection and transit from RRC_INACTIVE state to RRC_CONNECTED state. However, RRC connection setup and subsequently release to RRC_INACTIVE state for each small and infrequent data lead to power consumption and signalling overhead. Therefore, small data transmission in RRC_INACTIVE state without connection establishment should be studied (as discussed in 3GPP RP-193252).

To enable UL data transmission in RRC_INACTIVE state, Random Access Channel (RACH)-based method and/or pre-configured Physical Uplink Shared Channel (PUSCH) resources based method could be considered. The RACH-based method may include a 2-step Random Access (RA) and/or a 4-step RA. When some UL data (e.g. small data) is available for transmission while the UE is in RRC_INACTIVE state, the UE may initiate a RRC Resume procedure in RRC_INACTIVE state which triggers a RA procedure for the small data transmission.

For a 2-step RA (e.g. with small data), the UE may perform Random Access Resource selection and then send a Message A (MSGA) including a RA preamble and a PUSCH payload. The PUSCH payload may contain RRC resume request and the UL data (e.g. small data). In response to receiving the MSGA, the Network (NW) may send a Message B (MSGB) to inform the UE to complete the RA procedure and may transmit a RRC release message to keep the UE in the RRC_INACTIVE state. If the NW receives a RA preamble but fails to receive a PUSCH payload, the NW may send a MSGB to inform the UE to fall back to Msg3. The UE may use the UL grant in the MSGB to transmit a Msg3. The Msg3 may contain RRC resume request and the UL data (e.g. small data). In response to receiving the Msg3, the NW may send a Msg4 to inform the UE to complete RA procedure and may transmit a RRC release message to keep the UE in the RRC_INACTIVE state.

For a 4-step RA (e.g. with small data), the UE may perform Random Access Resource selection and then send a RA preamble. The NW may receive the RA preamble and send a RAR. In response to receiving the RAR, the UE may use the UL grant in the RAR to transmit a Msg3 which may contain RRC resume request and the UL data (e.g. small data). In response to receiving the Msg3, the NW may send a Msg4 to inform the UE to complete RA procedure and transmit a RRC release message to keep the UE in the RRC_INACTIVE state.

For the RACH-based method (e.g. 2-step RA, 4-step RA), an objective is to enable flexible payload sizes which are larger than the Rel-16 CCCH message size to support small data transmission (as discussed in 3GPP RP-193252). It can be expected that the data size of MSGA (or Msg3) with small data would be larger than the case without small data. It may also be expected that the MSGA transmission (or Msg3 transmission) with small data would be more difficult under the same radio condition compared to the MSGA transmission (or Msg3 transmission) without small data. After the initiation of small data transmission (e.g. via 2-step RA, 4-step RA, or pre-configured PUSCH resource), the radio condition may change from time to time during the procedure of small data transmission. If the radio condition becomes or is bad such that the UE cannot successfully transmit the small data (e.g. via MSGA, Msg3, or pre-configured PUSCH resource) in the RRC_INACTIVE state, it may be better to handle the failure promptly rather than repeated transmission failure.

To solve the issue, if a UE detects that it may be difficult to deliver UL data (e.g. small data) successfully and/or it is not suitable to continue the current procedure of small data transmission (e.g. due to poor radio condition, resource congestion, etc.), the UE could perform a fallback action (e.g. which may save UE power, ease the current problematic situation, and/or change to another procedure which may more likely to succeed). The UE may perform one or more of the following actions under one or more of the following conditions. Different alternatives may be combined or separately considered.

The action may include one or multiple of the following techniques:

### Stop the Ongoing Procedure of Small Data Transmission

The UE may stop (terminate, cancel, or suspend) the ongoing procedure of small data transmission. The procedure may be a 2-step RA. The procedure may be a 4-step RA. The procedure may be a UL transmission using a pre-configured PUSCH resource.

The UE may flush the HARQ buffer used for the transmission of the small data (or UL data). The UE may initiate another Random Access procedure. The UE may indicate a problem. The UE may reset the Medium Access Control (MAC).

Switch to Transmission without User Data, e.g. a Resume Procedure

The UE may switch from a procedure of small data transmission (e.g. 2-step RA, 4-step RA, pre-configured PUSCH transmission, the procedure including UL data) to a resume procedure without carrying user data (or UL data). The type of the transmission may be kept the same during the switch (e.g. from 2-step RA with small data transmission to 2-step RA for resume without small data, from 4-step RA with small data transmission to 4-step RA for resume without small data). The type of the transmission may be changed during the switch (e.g. from a 2-step RA to 4-step RA, from a pre-configured PUSCH transmission to a 2-step RA, from a pre-configured PUSCH transmission to a 4-step RA). The type of the transmission may include 2-step RA, 4-step RA, and/or pre-configured PUSCH transmission.

The UE may initiate a resume procedure to resume a RRC connection. The resume procedure may not carry user data (e.g. small data). The user data (e.g. small data) may be transmitted after the connection is resumed (e.g. after the UE enters connection mode).

During a resume procedure, the UE may transmit a resume request. The resume request may be a RRC message. The UE may use a 2-step RA procedure to transmit a resume request. The UE may use a 4-step RA procedure to transmit a resume request.

The UE may indicate the multiplexing and assembly entity to rebuild the data in the MSGA (or Msg3) buffer to exclude the small data. The UE may stop the RA procedure and/or reinitiate a RA procedure to resume.

As discussed in 3GPP TS 36.321, if the UL grant received in a RAR provided by the NW is not for EDT, the UE cancels the EDT. In the invention, the UE may cancel the small data transmission when the radio condition measured by the UE is below a threshold. The UE may cancel the small data transmission at different timing (e.g. before a MSGA or Msg3 transmission, upon failing to receive a MSGB or Msg4) without an indication from the NW. Then the UE could transmit the small data in RRC_CONNECTED state with more flexibility and effectiveness.

### Switch a Type for Small Data Transmission or Random Access Procedure

The UE may transmit the small data with a different type of transmission. The UE may switch from a first type of transmission to a second type of transmission. The type for transmission (e.g. the first type of transmission, the second type of transmission) may include 2-step RA, 4-step RA, and/or pre-configured PUSCH transmission. The UE may switch from a 2-step RA procedure to a 4-step RA procedure. The UE may switch from a 2-step RA with small data transmission to a 4-step RA with small data transmission. The UE may switch from a pre-configured PUSCH transmission to a 2-step RA with small data transmission. The UE may switch from a pre-configured PUSCH transmission to a 4-step RA with small data transmission.

The switch may be one shot, e.g. switch back to the first type of transmission after switching to the second type of transmission and the transmission is failed. For example, if the UE fails to receive a Msg4 in response to the Msg3 during the 4-step RA, the UE may backoff and transmit the MSGA.

The switch may be permanent, e.g. retry the second type of transmission after switching to the second type of transmission and the transmission is failed. For example, if the UE fails to receive a Msg4 in response to the Msg3 during the 4-step RA, the UE may backoff and transmit the RA preamble (Msg1).

### Backoff

The UE may perform a backoff during the ongoing procedure. For example, the UE selects a random backoff time for waiting and/or backs to the Random Access Resource selection procedure after the backoff. The UE may reselect RA preamble and PRACH resources, and/or the beam used for transmitting a preamble.

As discussed in 3GPP TS 38.321 with the running CR R2-1914798, a UE backs off when failing to receive the Msg3 or MSGB. In the invention, a UE may back off before transmitting a MSGA when the UE expects that the MSGA transmission would be failed. The UE could reselect the RA resources without trying to transmit a MSGA which would be failed.

### Wait

For example, the UE waits for a period of time, e.g. waits for the radio condition turning better. If the UE spends too much time on waiting, the UE may resume, backoff, and/or continue the RA procedure.

The UE may pause the RA procedure for a while, rather than transmitting the MSGA in a bad radio condition and then redoing the RA resource selection. The MSGA could have the chance to be transmitted in a better radio condition.

The condition may include one or multiple of the following:

Radio Condition Becomes or is Bad, e.g. Below a Threshold

The UE may take action if the UE detects that the current radio condition is not good enough. The radio condition may be below a configured threshold. The radio condition may be a delta below the radio condition where the procedure was initiated.

For example, before MSGA transmission (with small data), the UE may measure and/or derive the current radio condition and compare it with the threshold. If the radio condition is above the threshold, the UE transmits the MSGA with small data. If the radio condition is below the threshold, the UE may cancel the small data transmission, may back off to the Random Access Resource selection, may wait for a period of time, and/or may continue the RA procedure.

For example, before Msg3 transmission (with small data), the UE may measure and/or derive the current radio condition and compare it with the threshold. If the radio condition is above the threshold, the UE transmits the Msg3 with small data. If the radio condition is below the threshold, the UE cancels the small data transmission.

### Failure to Receive MSGB in Response to the Small Data Transmission

The UE may take action if the UE fails to receive MSGB in response to the MSGA including small data. The UE may consider MSGB reception failure if the UE does not receive MSGB successfully during a period of time (e.g. a response window) after transmission of MSGA. The UE may consider MSGB reception failure if the UE does not receive MSGB successfully (or cannot succeed the current procedure) during a period of time (e.g. a response window) after a number of preamble transmission (e.g. preambleTransMax).

### Failure to Receive Msg4 in Response to the Small Data Transmission

The UE may take action if the UE fails to receive Msg4 in response to the Msg3 including small data. The UE may consider Msg4 reception failure if the UE doesn't receive Msg4 successfully during a period of time (e.g. when a contention resolution timer is running) after transmission of Msg3. The UE may consider Msg4 reception failure if the UE does not receive Msg4 successfully (or cannot succeed the current procedure such contention resolution failure) during a period of time (e.g. when a contention resolution timer is running) after a number of preamble transmission (e.g. preambleTransMax).

### Reception of a Network Signalling

The UE may take action in response to reception of a network signalling. Details are specified in the following description.

To solve the issue, if a network node (or NW) detects that it may be difficult to succeed the current procedure of small data transmission (e.g. due to poor radio condition, resource congestion, etc.), the network node could transmit a signalling to a UE. The signalling may trigger the UE to perform a fallback action. In response to reception of the signalling, the UE may take one or multiple of the following actions. Different signalling may be used to indicate (or trigger) the UE to perform different actions. For example, a first signalling is used to indicate the UE to perform a first action. And a second signalling is used to indicate the UE to perform a second action. A signalling may be used to indicate the UE to perform which action (e.g. a first action or a second action).

The (fallback) action (e.g. the first action and/or the second action) may include one or multiple of the following techniques:

Switch to 4-Step RA with Small Data Transmission

NW may indicate the UE to switch to a 4-step RA with or without a UL grant. The UE may have an ongoing 2-step RA procedure with small data transmission. The UE may switch the RA type, e.g. from 2-step to 4-step. The UE may perform a 4-step RA procedure. The 4-step RA procedure may be with small data transmission. The UE may transmit the Msg3 with small data using a UL grant provided by the NW. The switch may be one shot, e.g. switch back to the first type of transmission after switching to the second type of transmission and the transmission is failed.

For example, if the UE fails to receive a Msg4 in response to the Msg3 during the 4-step RA, the UE may backoff and transmit the MSGA. The switch may be permanent, e.g. retry the second type of transmission after switching to the second type of transmission and the transmission is failed. For example, if the UE fails to receive a Msg4 in response to the Msg3 during the 4-step RA, the UE may backoff and transmit the RA preamble (Msg1).

As described in CN110583093A (entitled “Random access method, receiving method, device, equipment and medium”), the UE may switch the 2-step RA to 4-step RA when the SS/PBCH block (SSB) meets a target condition, e.g. the signal quality of all SSBs does not reach the measurement threshold. In the invention, the NW may switch 2-step RA to 4-step RA when the radio condition is not qualified for the UE to transmit the small data. The measurement by the NW is based on a UL reference (e.g. sounding reference signal) which could represent the UL radio condition more properly. Also the NW could know the radio condition of the UEs comprehensively.

Switch to 2-Step RA without Small Data Transmission

For example, the NW indicates the UE to cancel the small data transmission with or without a UL grant. The UE cancels the small data transmission. The UE may indicate the multiplexing and assembly entity to rebuild the data in the MSGA buffer to exclude the small data. The UE may transmit the MSGA without small data using a UL grant provided by the NW. The UE may back off to the Random Access Resource selection procedure and transmit a RA preamble. The UE may stop the RA procedure and indicate upper layer to reinitiate a 2-step RA procedure to resume. Then the UE could transmit the small data in RRC_CONNECTED state with more robustness.

Switch to 4-Step RA without Small Data Transmission

For example, the NW indicates the UE to switch to 4-step RA and/or cancel the small data transmission with or without a UL grant. The UE switches the RA type and/or cancels the small data transmission. The UE may indicate the multiplexing and assembly entity to rebuild the data in the MSGA buffer to exclude the small data. The UE may transmit the Msg3 without small data using a UL grant provided by the NW. The UE may back off to the Random Access Resource selection procedure and transmit a RA preamble. The UE may stop the RA procedure and indicate upper layer to reinitiate a 4-step RA procedure to resume.

The switch may be one shot, e.g. switch back to the first type of transmission after switching to the second type of transmission and the transmission is failed. For example, if the UE fails to receive a Msg4 in response to the Msg3 during the 4-step RA, the UE may backoff and transmit the MSGA.

The switch may be permanent, e.g. retry the second type of transmission after switching to the second type of transmission and the transmission is failed. For example, if the UE fails to receive a Msg4 in response to the Msg3 during the 4-step RA, the UE may backoff and transmit the RA preamble (Msg1).

If the NW indicates the UE to switch from a 2-step RA with small data to a 4-step RA without small data, the small data could be transmitted in RRC_CONNECTED state after resume. When the UE is in a very bad radio condition, the small data transmission could be completed sooner and with more robustness.

Extend the Response Window (e.g. msgB-Response Window, Ra-Response Window)

For example, the NW indicates the UE to extend the response window, e.g. waits for the radio condition turning better. The UE extends the msgB-Response Window or ra-Response Window, and waits for a MSGB or Msg3. If the waiting time is too long, the NW may indicate the UE to switch to 4-step RA, to resume, and/or to continue the RA procedure.

The NW could pause the RA procedure for a while. Rather than transmitting the Msg3 (with small data) in a bad radio condition and then redoing the RA resource selection by the UE. The small data could have the chance to be successfully transmitted in a better radio condition.

### Resume

For example, the NW indicates the UE to cancel the small data transmission. The UE cancels the small data transmission. The UE may indicate the multiplexing and assembly entity to rebuild the data in the MSGA (or Msg3) buffer to exclude the small data. The UE may stop the RA procedure and indicate upper layer to reinitiate a RA procedure to resume.

As discussed in 3GPP TS 36.321, if the NW transmits a RAR with the UL grant not for EDT, the UE cancels the EDT. In the invention, the NW may indicate the UE to cancel the small data transmission when the Msg3 transmission is failed and the radio condition measured by the NW is below a threshold. The NW could indicate the UE to cancel the small data transmission when a failure is really happened.

The signaling may be or include one or multiple of the following constructs:
MSGB (of the 2-step RA)—For example, the indication could be included in a fallbackRAR. The indication could also be included in a subheader. The indication could be included in other payloads.
RAR (of the 4-step RA)—For example, the indication is included in a subheader. The indication could also be included in the reserved bit of RAR payload. The indication could be included in the UL grant of RAR payload.
a message in response to MSGA and/or Msg3 with small data
Downlink Control Information (DCI)
MAC Control Element (CE)
RRC message

The network may determine to transmit the signalling to the UE due to the following techniques:

### Detection of Radio Condition Becoming Bad

For example, before MSGB transmission (e.g. fallbackRAR) with a UL grant for the small data, the NW may measure and/or derive the current radio condition. If the radio condition is qualified for the UE to transmit the small data, the NW may transmit the MSGB. If the radio condition is bad, the NW may indicate the UE to switch to 4-step RA, to extent the msgB-Response Window, and/or to cancel the small data. The NW may continue the RA procedure.

For example, before RAR transmission with a UL grant for the small data, the NW may measure and/or derive the current radio condition. If the radio condition is qualified for the UE to transmit the small data, the NW may transmit the RAR. If the radio condition is bad, the NW may indicate the UE to extent the ra-Response Window, and/or to cancel the small data. The NW may continue the RA procedure.

### Too Many Packet Loss

For example, upon the NW failing to receive the Msg3 with small data in response to MSGB, the NW may measure and/or derive the current radio condition. If the radio condition is qualified for the UE to transmit the small data, the NW may ask for a retransmission. If the radio condition is bad, the NW may indicate the UE to cancel the small data transmission and/or to switch to 4-step RA.

For example, upon the NW failing to receive Msg3 with the small data in response to RAR the NW may measure and/or derive the current radio condition. If the radio condition is qualified for the UE to transmit the small data, the NW may ask for a retransmission. If the radio condition is bad, the NW may indicate the UE to cancel the small data transmission.

The UE may switch from a first type of transmission to a second type of transmission. The first type of transmission may be with small data. The first type of transmission may be without small data. The second type of transmission may be with small data. The second type of transmission may be without small data. The first type of transmission may be a 2-step RA. The first type of transmission may be a 4-step RA. The first type of transmission may be a pre-configured PUSCH transmission. The second type of transmission may be a 2-step RA. The second type of transmission may be a 4-step RA. The second type of transmission may be a pre-configured PUSCH transmission.

The switch may be one shot, e.g. switch back to the first type of transmission after switching to the second type of transmission and the transmission is failed. For example, if the UE fails to receive a Msg4 in response to the Msg3 during the 4-step RA, the UE may backoff and transmit the MSGA.

The switch may be permanent, e.g. retry the second type of transmission after switching to the second type of transmission and the transmission is failed. For example, if the UE fails to receive a Msg4 in response to the Msg3 during the 4-step RA, the UE may backoff and transmit the RA preamble (Msg1).

The radio condition may be measured and/or derived by the UE. The radio condition may be derived from one or more measured result(s) from the UE. The radio condition and/or the measurement result may be with respect to a pathloss reference, an average of a set of pathloss references, and/or a reference signal of a beam (e.g. SSB, CSI-RS). The radio condition and/or the measurement result(s) may be based on a cell group, a serving cell, a carrier, a Bandwidth Part (BWP), and/or a beam. The radio condition may be represented by Reference Signal Received Power (RSRP), Reference Signal Received Quality (RSRQ), and/or Signal-to-Interference-Plus-Noise Ratio (SINR).

The radio condition may be measured and/or derived by the NW. The radio condition may be derived from one or more measured result(s) from the NW. The radio condition and/or the measurement result may be with respect to a sounding reference signal, and/or an average of a set of sounding reference signals. The radio condition may be represented by RSRP, RSRQ, and/or SINR.

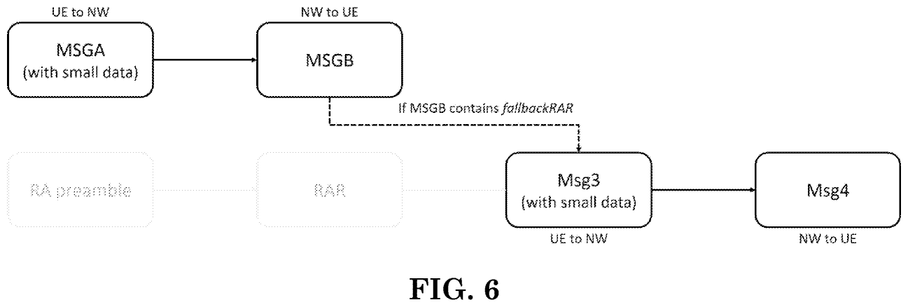

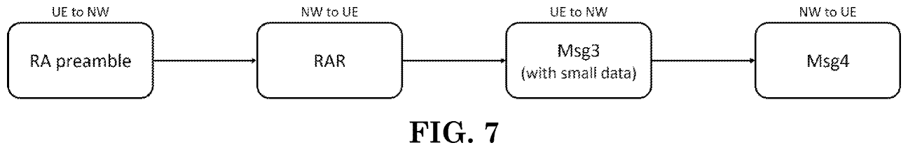

The RACH-based small data transmission may be a 2-step RA, as shown in FIG. 6 which is a flow chart of a 2-step random access procedure with small data according with one exemplary embodiment. The RACH-based small data transmission may also be a 4-step RA, as showed in FIG. 7 which is a flow chart of a 4-step random access procedure with small data according with one exemplary embodiment. The RACH-based small data transmission may be applicable when the UE is in RRC_INACTIVE state. The RACH-based small data transmission may be contention based. The RACH-based small data transmission may be contention-free. A RSRP threshold may be provided in the RACH configuration on each BWP to determine the RA types (e.g. 2-step RA, 4-step RA) as discussed in 3GPP R2-1915889. The RACH-based small data transmission in RRC_INACTIVE state may be contention-based and/or contention free, or based on the configuration from the NW and/or on the radio condition.

A RACH-based small data transmission procedure may be initiated upon (or in response to) the upper layer indicating a RRC resume procedure for small data transmission, e.g. when UL data arrival and/or with periods. A RACH-based small data transmission procedure may be initiated if the NW and the UE both support small data transmission and/or the related configuration is configured on the UE. In addition, a RACH-based small data transmission procedure may be initiated if the size of the small data is less than or equal to a TB size indicated in the related configuration, the system information, the dedicated RRC signaling and/or the DCI. One or more conditions mentioned above may be applied jointly.

If the radio condition measured by the UE is below a threshold, it may imply that the small data transmission in the RA procedure cannot success. The UE may cancel the small data transmission in the RA procedure, e.g. process a resume procedure. The UE may back off to Random Access Resource selection procedure. The UE may wait for a period of time, e.g. wait for better radio condition. The UE may continue the RA procedure. Some examples are provided below.

In one example, the UE may cancel the small data transmission and initiate (or fall back to or proceed with) a RA procedure to resume. The RA procedure may be 2-step RA or 4-step RA. The UE may rebuild the MSGA (or Msg3) to exclude the small data. The UE transmits a MSGA (or Msg3) containing RRC resume request without the small data. The small data could be transmitted in RRC_CONNECTED state. The radio condition may be measured each time before the UE transmits the MSGA with small data. The radio condition may be measured each time before the UE transmits the Msg3 with small data. The radio condition may be measured each time upon the UE fails to receive the MSGB in response of the small data transmission. The radio condition may be measured each time upon the UE fails to receive the Msg4 in response of the small data transmission.

In one example, the UE may back off to the Random Access Resource selection procedure. The UE may use the reselected RA resources to transmit the small data in a MSGA. The radio condition may be measured each time before the UE transmits the MSGA with small data.

In one example, the UE may wait for a while and then measures the radio condition again. If the radio condition is above the threshold, the UE may transmit the MSGA with small data. If the radio condition is below the threshold, the UE may continue waiting. If the UE spends too much time on waiting, the UE may cancel the small data transmission and initiates (or fall back to or proceed with) a RA procedure to resume. The RA procedure may be a 2-step RA or a 4-step RA. The UE may rebuild the MSGA or Msg3 to exclude the small data. The UE may transmit a MSGA containing RRC resume request without the small data. The small data could be transmitted in RRC_CONNECTED state. The radio condition may be measured each time before the UE transmits the MSGA with small data.

In one example, the UE may wait for a while and then measures the radio condition again. If the radio condition is above the threshold, the UE may transmit the MSGA with small data. If the radio condition is below the threshold, the UE may continue waiting. If the UE spends too much time on waiting, the UE may back off to the Random Access Resource selection procedure. The UE may use the reselected RA resources to transmit the small data in a MSGA. The radio condition may be measured each time before the UE transmits the MSGA with small data.

In one example, the UE may wait for a while and then measures the radio condition again. If the radio condition is above the threshold, the UE may transmit the MSGA with small data. If the radio condition is below the threshold, the UE may continue waiting. If the UE spends too much time on waiting, the UE may continue the RA procedure and transmit the MSGA with small data, regardless the radio condition. If the small data transmission fails, the UE may back off to the Random Access Resource selection procedure and transmit the small data in the MSGA. The radio condition may be measured each time before the UE transmits the MSGA with small data.

If the radio condition measured by the NW is not qualified for the small data transmission in the RA procedure, the NW may indicate the UE to switch to 4-step RA. The NW may indicate the UE to cancel the small data transmission in the RA procedure and process a resume procedure. The NW may indicate the UE to wait for a period of time, e.g. wait for the radio condition turning better. The NW may continue the RA procedure. Some example are shown below.

In one example, the NW may indicate the UE to switch to 4-step RA. The UE may switch the RA type to 4-step. The UE may transmit the small data in the Msg3 with the UL grant in a MSGB provided by the NW. The UE may reselect the RA resource and transmit the RA preamble (Msg1), then transmit the small data in a Msg3 with the UL grant in a RAR provided by the NW. If the UE fails to receive a Msg4 in response to the Msg3, the UE may backoff and transmit the MSGA. If the UE fails to receive a Msg4 in response to the Msg3, the UE may backoff and transmit the RA preamble. The NW may indicate the UE by a MSGB. The NW may indicate the UE by a MAC CE. The NW may indicate the UE by a RRC message. The NW may indicate the UE by a DCI. The radio condition may be measured each time before the NW transmits the MSGB (e.g. with fallbackRAR) with the UL grant for small data. The radio condition may be measured each time when the NW fails to receive the Msg3 with small data, and the NW has transmitted the MSGB (e.g. with fallbackRAR) with the UL grant for small data.

In one example, the NW may indicate the UE to cancel the small data transmission and initiates (or fall back to or proceed with) a RA procedure to resume. The RA procedure may be a 2-step RA or a 4-step RA. The UE may rebuild the MSGA or Msg3 to exclude the small data. The UE may transmit a MSGA (or Msg3) containing RRC resume request without the small data. The small data could be transmitted in RRC_CONNECTED state. The NW may indicate the UE by a MAC CE. The NW may indicate the UE by a RRC message. The NW may indicate the UE by a DCI. The radio condition is measured each time upon the NW failing to receive the Msg3 with small data. The NW may have transmitted the MSGB (e.g. with fallbackRAR) with the UL grant for small data. The NW may have transmitted the RAR with the UL grant for small data.

In one example, the NW may wait a while, and may then measure the radio condition again. If the radio condition is above the threshold, the NW may transmit the MSGB (or RAR) with a UL grant for small data. If the radio condition is below the threshold, the NW may continue waiting. If the radio condition is below the threshold, the NW may indicate the UE to extent the response window (e.g. msgB-Response Window, ra-Response Window).

The UE may extend the response window (e.g. msgB-Response Window, ra-Response Window), and may wait for a MSGB (or RAR) with UL grant for the small data; then transmits the small data in a Msg3. If the NW spends too much time on waiting, it may indicate the UE to cancel the small data transmission and initiate (or fall back to or proceed with) a RA procedure to resume. The RA procedure may be a 2-step RA or a 4-step RA. The UE may rebuild the MSGA or Msg3 to exclude the small data. The UE may transmit a MSGA (or Msg3) containing RRC resume request without the small data. The small data could be transmitted in RRC_CONNECTED state. The NW may indicate the UE by a MSGB (or RAR).

The NW may indicate the UE by a MAC CE. The NW may inform the UE by a RRC message. The NW may indicate the UE by a DCI. The radio condition may be measured each time before the NW transmits the MSGB (e.g. with fallbackRAR) with the UL grant for small data. The radio condition may be measured each time before the NW transmits the RAR with the UL grant for small data.

In one example, the NW may wait a while and then measures the radio condition again. If the radio condition is above the threshold, the NW may transmit the MSGB (or RAR) with UL grant for small data. If the radio condition is below the threshold, the NW may continue waiting. If the radio condition is below the threshold, the NW may indicate the UE to extent the response window (e.g. msgB-Response Window, ra-ResponseWindow). The UE may extend the response window (e.g. msgB-Response Window, ra-ResponseWindow) and wait for a MSGB (or RAR) with UL grant for the small data, and may then transmit the small data in a Msg3.

If the NW spends too much time on waiting, it may continue the RA procedure and transmit the MSGB (or RAR) with the UL grant for small data, regardless the radio condition. If the small data transmission fails, the UE may back off to the Random Access Resource selection procedure and transmit the small data in the Msg3. The NW may indicate the UE by a MSGB (or RAR). The NW may indicate the UE by a MAC CE. The NW may indicate the UE by a RRC message. The NW may indicate the UE by a DCI. The radio condition may be measured each time before the NW transmits the MSGB (e.g. with fallbackRAR) with the UL grant for small data. The radio condition may be measured each time before the NW transmits the RAR with the UL grant for small data.

In one example, the NW may wait a while and then measures the radio condition again. If the radio condition is above the threshold, the NW may transmit the MSGB with UL grant for small data. If the radio condition is below the threshold, the NW may continue waiting. If the radio condition is below the threshold, the NW may indicate the UE to extent the response window (e.g. msgB-ResponseWindow). The UE may extend the response window (e.g. msgB-ResponseWindow) and wait for a MSGB with UL grant for the small data, and may then transmit the small data in a Msg3. If the NW spends too much time on waiting, it may indicate the UE to switch to a 4-step RA.

The UE may switch the RA type to 4-step. The UE may transmit the small data in the Msg3 with a UL grant in the MSGB provided by the NW. The UE may reselect the RA resource and transmit the RA preamble (Msg1), and may then transmit the small data in the Msg3 with the UL grant in RAR provided by the NW. If the UE fails to receive a Msg4 in response to the Msg3, the UE may backoff and transmit the MSGA. If the UE fails to receive a Msg4 in response to the Msg3, the UE may backoff and transmit the RA preamble.

The NW may indicate the UE by a MSGB. The NW may indicate the UE by a MAC CE. The NW may indicate the UE by a RRC message. The NW may indicate the UE by a DCI. The radio condition may be measured each time before the NW transmits the MSGB (e.g. with fallbackRAR) with the UL grant for small data.

The UE may initiate a 4-step RA to transmit small data when the upper layer indicates a small data transmission and the RSRP is below a threshold (e.g. rsrp-Threshold-msgA). The UE may transmit a RA preamble. If the UE receives a RAR in response to the RA preamble with UL grant not for small data, the UE may cancel the small data transmission and/or continue the RA procedure to resume.

The UE may initiate a 2-step RA (without small data) when the RSRP is above a threshold (e.g. rsrp-Threshold-msgA). If the UE detects the RSRP below a threshold (e.g. rsrp-Threshold-msgA) during the RA procedure (e.g. it may be difficult to deliver UL data successfully), the UE may continue the 2-step RA procedure (without small data).

The UE may initiate a 2-step RA (without small data) when the RSRP is above a threshold (e.g. rsrp-Threshold-msgA). The UE may transmit a MSGA and then receives a fallback message (e.g. fallbackRAR) in response of MSGA with. In response to the fallback message, the UE may transmit a Msg3 with the UL grant in the fallback message. If the UE fails to receive a Msg4 in response to the Msg3, the UE may back off and/or transmits the MSGA.

The UE may have an ongoing 2-step RA procedure. The UE may have an ongoing 4-step RA procedure. The UE may have a pre-configured PUSCH resource. The UE may have an ongoing procedure for small data transmission. The UE may be in RRC_INACTIVE state, RRC_IDLE state, or RRC_CONNECTED state.

The UE may receive some configurations related to the radio condition and the RA procedure for small data transmission provided by the NW. For example, the configuration (namely, the related configuration) may include a threshold to determine the small data transmission. For example, the related configuration may include timers, counters, windows, and/or other parameters to wait before the small data transmission. The related configuration may be provided in system information, RRC signaling, and/or MAC CE.

The UE may be referred to as the UE, a MAC entity of the UE, or a multiplexing and assembly entity of the UE. The UE may be a New RAT/Radio (NR) device. The UE may be a NR-light device, as discussed in 3GPP RP193238. The UE may be a reduced capability device, as discussed in 3GPP RP193238. The UE may be a mobile phone, a wearable device, a sensor, or a stationary device.

The NW may be a base station, an access point, an eNB, or a gNB.

A RA procedure could be for small data transmission if the upper layer indicates a small data transmission. A RA procedure could be for small data transmission if the upper layer requests the resume of a suspended RRC connection for transmitting small data in RRC_INACTIVE state.

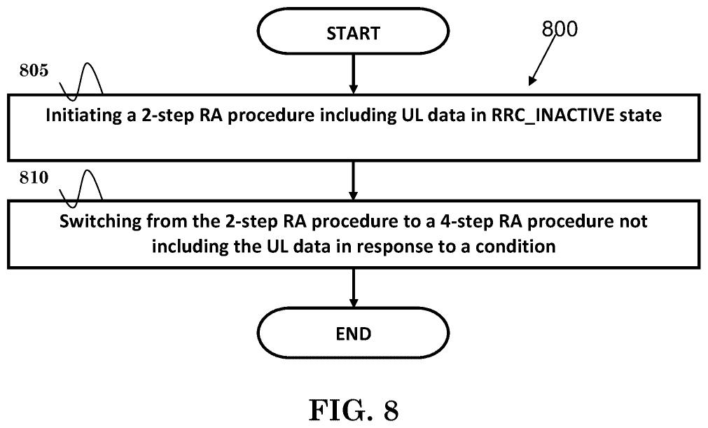

FIG. 8 is a flow chart 800 according to one exemplary embodiment from the perspective of a UE. In step 805, the UE initiates a 2-step RA procedure including UL data in RRC_INACTIVE state. In step 810, the UE switches from the 2-step RA procedure to a 4-step RA procedure not including the UL data in response to a condition.

In one embodiment, the condition may be that the UE receives a network signaling. The network signaling may be an indication in a Random Access Response. The network signaling may be an indication in a MSGB.

In one embodiment, the condition may be that the UE cannot successfully complete the 2-step RA procedure after a number of preamble transmissions. The number of preamble transmissions may exceed a configured threshold.

In one embodiment, the condition may be that a radio condition of the UE becomes or is below a radio condition threshold. The radio condition of the UE may be a RSRP of a pathloss reference.

In one embodiment, the UE could perform the switching by stopping the 2-step RA procedure and initiating the 4-step RA procedure. Furthermore, the UE could transmit the Uplink (UL) data after entering RRC_CONNECTED state. The 2-step RA procedure could be initiated in response to an upper layer request.

Referring back to FIGS. 3 and 4, in one exemplary embodiment of a UE, the UE 300 includes a program code 312 stored in the memory 310. The CPU 308 could execute program code 312 to enable the UE (i) to initiate a 2-step RA procedure including UL data in RRC_INACTIVE state, and (ii) to switch from the 2-step RA procedure to a 4-step RA procedure not including the UL data in response to a condition. Furthermore, the CPU 308 can execute the program code 312 to perform all of the above-described actions and steps or others described herein.

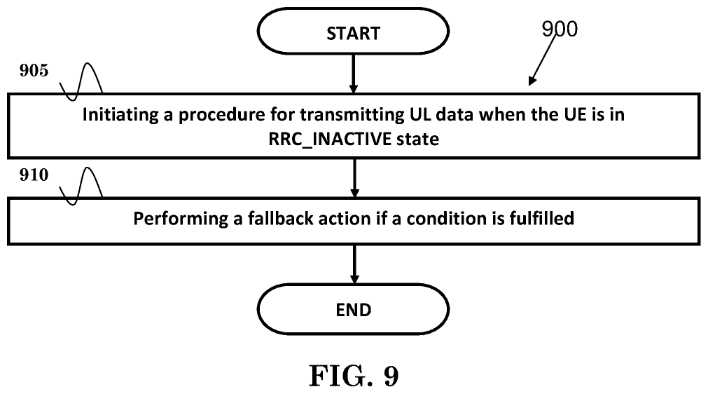

FIG. 9 is a flow chart 900 according to one exemplary embodiment from the perspective of a UE. In step 905, the UE initiates a procedure for transmitting UL data when the UE is in RRC_INACTIVE state. In step 910, the UE performs a fallback action if a condition is fulfilled.

In one embodiment, (all or at least part of) the UL data (i.e. small data) could be transmitted in MSGA, Msg3 and/or pre-configured Physical Uplink Shared Channel (PUSCH) resource.

In one embodiment, the condition may be that the UE receives a network signaling. The condition may also be that the UE fails to receive MSGB in response to the small data transmission. Furthermore, the condition may be that the UE fails to receive Msg4 in response to the small data transmission.

In one embodiment, the condition may be that the radio condition becomes or is bad (e.g., lower or smaller than a radio condition threshold). The radio condition could be measured and/or derived by the UE. The radio condition could be with respect to a pathloss reference, an average of a set of pathloss references, and/or a reference signal of a beam (e.g. SSBs and/or CSI-RSs). The radio condition could be based on a cell group, a serving cell, a carrier, a BWP, and/or a beam.

In one embodiment, the fallback action could be (i) stopping the (ongoing) small data transmission, (ii) canceling the small data transmission, (iii) switching the transmission type, (iv) backing off to the RA resource selection procedure, and/or (v) waiting for a period of time. If the UE stop the (ongoing) small data transmission, the UE may flush the HARQ buffer used for the transmission of the small data, reinitiates Random Access procedure, and/or resets the MAC. If the UE cancels the small data transmission, the UE may initiate a resume procedure, stop an ongoing RA procedure and reinitiate a RA procedure to resume, and/or rebuild the data in the MSGA (or Msg3) buffer to exclude the small data.

If the UE switches the transmission type, the UE may switch from a 2-step RA to 4-step RA, from a pre-configured PUSCH to 2-step RA, and/or from a pre-configured PUSCH to 4-step RA. Furthermore, if the UE switches the transmission type, the switch may be one shot and/or permanent.

If the UE spends too much time (e.g., bigger than a parameter for waiting time) on waiting, the UE may cancel the small data transmission, back off to RA resource selection procedure, and/or continue the small data transmission.

In one embodiment, the UE could receive a related configuration related to small data transmission (e.g. radio condition threshold, and/or parameter for waiting time) provided by the NW. The UE could also receive a network signaling.

In one embodiment, the related configuration could be provided in system information, RRC signaling, and/or MAC CE. The network signaling could be a MSGB, a Random Access Response (RAR), a MAC CE, a RRC message, and/or a Downlink Control Information (DCI).

In one embodiment, the UE may be a NR device and/or a NR-light device. The UE may also be a reduced capability device and/or a stationary device. Furthermore, the UE may be a mobile phone, a wearable device, and/or a sensor. The UE may be with mobility capability and/or with no mobility capability.

Referring back to FIGS. 3 and 4, in one exemplary embodiment of a UE, the UE 300 includes a program code 312 stored in the memory 310. The CPU 308 could execute program code 312 to enable the UE (i) to initiate a procedure for transmitting UL data when the UE is in RRC_INACTIVE state, and (ii) to perform a fallback action if a condition is fulfilled. Furthermore, the CPU 308 can execute the program code 312 to perform all of the above-described actions and steps or others described herein.

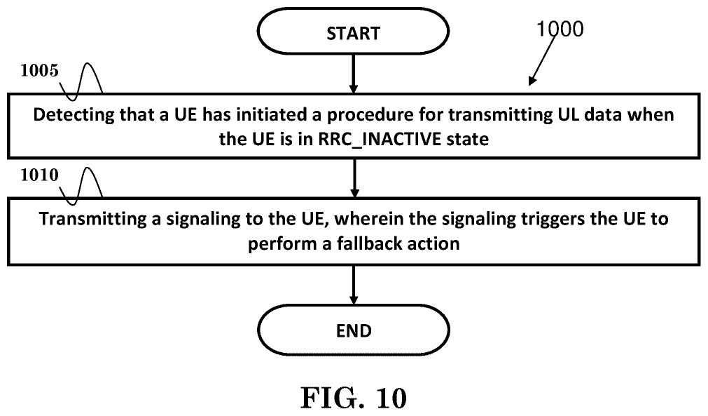

FIG. 10 is a flow chart 1000 according to one exemplary embodiment from the perspective of a NW. In step 1005, the NW detects that a UE has initiated a procedure for transmitting UL data when the UE is in RRC_INACTIVE state. In step 1010, the UE transmits a signaling to the UE, wherein the signaling triggers the UE to perform a fallback action.

In one embodiment, (all or at least part of) the UL data (i.e. small data) may be received from MSGA, Msg3, and/or pre-configured PUSCH resource.

In one embodiment, the condition may be that the radio condition becomes or is bad (e.g., lower/smaller than a radio condition threshold). The condition may also be that the NW detects too many packet loss (e.g. the NW fails to receive the Msg3 with small data in response to MSGB and/or RAR). The radio condition may be measured and/or derived by the NW. The radio condition may be with respect to a sounding reference signal, and/or an average of a set of sounding reference signals.

In one embodiment, the fallback action may be (i) switching to 4-step RA with small data transmission, (ii) switching to 2-step RA without small data transmission, (iii) switching to 4-step RA without small data transmission, (iv) extending the response window (e.g. msgB-Response Window, ra-Response Window), and/or (v) resuming to RRC_CONNECT state. If the UE extends the response window for too long, the NW may trigger (or indicate) the UE to cancel the small data transmission, switch to 4-step RA, and/or continue the small data transmission. The NW may trigger (or indicate) the UE by sending a MSGB, a RAR, a MAC CE, a RRC message, and/or a DCI. The NW may transmit a RRC release message to keep the UE in the RRC_INACTIVE state after the RA procedure with small data is completed.

In one embodiment, the NW could send a related configuration related to small data transmission (e.g. radio condition threshold, and/or parameter for waiting time) to the UE. The related configuration could be provided in system information, dedicated RRC signaling, and/or MAC CE. The NW could be a base station, an access point, an eNB, and/or a gNB.

In one embodiment, the small data transmission may be 2-step RA, 4-step RA, and/or pre-configured PUSCH. The RA may be contention-based and/or contention free.

In one embodiment, the small data transmission could be initiated upon the upper layer indicates a RRC resume procedure for small data transmission. The small data transmission could also be initiated upon the upper layer requests the resume of a suspended RRC connection for transmitting small data in RRC_INACTIVE state. Furthermore, the small data transmission could be initiated if the UE and NW both support small data transmission, or if the related configuration is configured on the UE. In addition, the small data transmission could be initiated if the uplink data size is less than or equal to a TB size indicated in the related configuration, the system information, the dedicated RRC signaling, and/or the DCI.

In one embodiment, the radio condition may be represented by RSRP, RSRQ, and/or SINR.

Referring back to FIGS. 3 and 4, in one exemplary embodiment of a network, the network 300 includes a program code 312 stored in the memory 310. The CPU 308 could execute program code 312 to enable the network to (i) to detect that a UE has initiated a procedure for transmitting UL data when the UE is in RRC_INACTIVE state, and (ii) to transmit a signaling to the UE, wherein the signaling triggers the UE to perform a fallback action. Furthermore, the CPU 308 can execute the program code 312 to perform all of the above-described actions and steps or others described herein.

Various aspects of the disclosure have been described above. It should be apparent that the teachings herein could be embodied in a wide variety of forms and that any specific structure, function, or both being disclosed herein is merely representative. Based on the teachings herein one skilled in the art should appreciate that an aspect disclosed herein could be implemented independently of any other aspects and that two or more of these aspects could be combined in various ways. For example, an apparatus could be implemented or a method could be practiced using any number of the aspects set forth herein. In addition, such an apparatus could be implemented or such a method could be practiced using other structure, functionality, or structure and functionality in addition to or other than one or more of the aspects set forth herein. As an example of some of the above concepts, in some aspects concurrent channels could be established based on pulse repetition frequencies. In some aspects concurrent channels could be established based on pulse position or offsets. In some aspects concurrent channels could be established based on time hopping sequences. In some aspects concurrent channels could be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for a User Equipment (UE), comprising:
initiating a first resume procedure for small data transmission (SDT), wherein the SDT is performed by configured resources;
transmitting a first Radio Resource Control (RRC) message during the first resume procedure;
receiving a second RRC message in response to the first RRC message;
in response to receiving the second RRC message:
terminating the SDT; and
resetting a Medium Access Control (MAC) of the UE; and
after terminating the SDT, initiating a second resume procedure.

2. The method of claim 1, wherein the first RRC message is a RRC resume request.

3. The method of claim 1, wherein the SDT is used for transmitting data in RRC_INACTIVE state.

4. The method of claim 1, wherein the first resume procedure is initiated by upper layers.

5. The method of claim 1, wherein the configured resources are Configured Grant (CG) Type 1.

6. The method of claim 1, wherein the UE is in RRC_INACTIVE state.

7. The method of claim 1, wherein the second resume procedure is not for SDT or for SDT.

8. The method of claim 1, wherein the second resume procedure is performed by a 2-step RA, a 4-step RA or the configured resources.

9. The method of claim 1, further comprising:
transmitting a third RRC message during the second resume procedure, wherein the third RRC message is another RRC resume request.

10. The method of claim 1, further comprising:
entering RRC_CONNECTED state in response to the second resume procedure.

11. A User Equipment (UE), comprising:
a control circuit;
a processor installed in the control circuit; and
a memory installed in the control circuit and operatively coupled to the processor;
wherein the processor is configured to execute a program code stored in the memory to:
initiate a first resume procedure for small data transmission (SDT), wherein the SDT is performed by configured resources;
transmit a first Radio Resource Control (RRC) message during the first resume procedure;
receive a second RRC message in response to the first RRC message;
in response to receiving the second RRC message:
terminate the SDT; and
reset a Medium Access Control (MAC) of the UE; and
after terminating the SDT, initiate a second resume procedure.

12. The UE of claim 11, wherein the first RRC message is a RRC resume request.

13. The UE of claim 11, wherein the SDT is used for transmitting data in RRC_INACTIVE state.

14. The UE of claim 11, wherein the first resume procedure is initiated by upper layers.

15. The UE of claim 11, wherein the configured resources are Configured Grant (CG) Type 1.

16. The UE of claim 11, wherein the UE is in RRC_INACTIVE state.

17. The UE of claim 11, wherein the second resume procedure is not for SDT or for SDT.

18. The UE of claim 11, wherein the second resume procedure is performed by a 2-step RA, a 4-step RA or the configured resources.

19. A non-transitory computer-readable medium comprising processor-executable instructions that when executed cause performance of operations, the operations comprising:
initiating a first resume procedure for small data transmission (SDT), wherein the SDT is performed by configured resources;
transmitting a first Radio Resource Control (RRC) message during the first resume procedure;
receiving a second RRC message in response to the first RRC message;
in response to receiving the second RRC message:
terminating the SDT; and
resetting a Medium Access Control (MAC); and
after terminating the SDT, initiating a second resume procedure.

20. The non-transitory computer-readable medium of claim 19, wherein the first RRC message is a RRC resume request.
